(19) United States
(12) Patent Application Publication
(10) Pub. No.: US 2017/0229141 A1
(43) Pub. Date: Aug. 10, 2017

(54) MANAGING READ AND WRITE ERRORS UNDER EXTERNAL VIBRATION

(71) Applicant: HGST Netherlands B.V., Amsterdam (NL)

(72) Inventors: Hiroshi Ide, Tokyo (JP); Masaomi Ikeda, Kanagawa (JP); Shuichi Hashimoto, Kanagawa (JP); Tasuku Miyazawa, Kanagawa (JP)

(21) Appl. No.: 15/016,017

(22) Filed: Feb. 4, 2016

(51) Int. Cl. G11B 5/596; G11B 20/12

(52) U.S. Cl. CPC G11B 5/59627; G11B 20/1217; G11B 2020/1238; G11B 2020/1292

(57) ABSTRACT

Systems and techniques for writing data to a Shingled Magnetic Recording (SMR) magnetic data storage device. At least one processor may determine whether the distance between a first data track and a second data track is less than a threshold distance. If the distance is less than a threshold distance, the at least one processor may cause a write head to refrain from writing to the sector of the second data track. The at least one processor may cause data from the first data track to be copied to another storage location and write data to the sector of the second data track.

### TECHNICAL FIELD

This disclosure relates to storage devices, such as shingled magnetic data storage devices.

### BACKGROUND

Hard disk drives (HDD) store data in annular tracks in magnetic storage media. One way to increase HDD capacity is to increase the tracks-per inch-(TPI) by reducing the track width, or reducing the spacing between tracks. Shingled Magnetic Recording (SMR) further increases TPI by using partially overlapping tracks, like roof shingles. As the HDD writes new data in track N+1, track N+1 partially overlaps the previously written, adjacent track N. Because the reader element is smaller than the writer element, HDD systems can read the data from the shingled track without losing data integrity or reliability.

### SUMMARY

In one example, the disclosure is directed to a method including, during writing of data to a second data track of a hard drive, determining, by at least one processor and based on a position error signal (PES) for a sector of the second data track, whether the distance between the sector of the second data track and a corresponding sector of a first data track is less than a threshold distance. In one example, the second data track is adjacent to the first data track and the first data track stores previously written data. The method may also include, in response to determining that the distance between the sector of the first data track and the corresponding sector of the second data track is less than the threshold distance: causing, by the at least one processor, a write head to refrain from writing data to the corresponding sector of the second data track; and setting, by the at least one processor, an indicator associated with the second data track indicating the data was not written to the corresponding sector of the second data track. The method may further include, during writing of data to a fourth data track of the hard drive, determining, by the at least one processor and based on a PES for a sector of a third data track of the hard drive and a PES for a corresponding sector of the fourth data track, whether the distance between the sector of the third data track and the corresponding sector of the fourth data track is less than the threshold distance. In one example, the fourth data track is adjacent to the third track and the third data track stores previously written data. The method may include in response to determining that the distance between the sector of the third data track and the corresponding sector of the fourth data track is less than the threshold distance: setting, by the at least one processor, an indicator associated with the third data track indicating the sector of the third data track may be squeezed; and causing, by the at least one processor, a write head to write data to the corresponding sector of the fourth data track.

In one example, the disclosure is directed to a method including causing, by at least one processor, data from a first data track of the hard drive to be copied to a secondary write buffer. The method may also include, during writing of data to a second data track of the hard drive, determining, by the at least one processor and based on a position error signal (PES) for a sector of the first data track and a PES for a corresponding sector of the second data track, whether the distance between the sector of the first data track and the corresponding sector of the second data track is less than a threshold distance. In one example, the second data track is adjacent to the first data track and the first data track stores previously written data. The method may further include, in response to determining that the distance between the sector of the first data track and the corresponding sector of the second data track is less than the threshold distance: setting, by the at least one processor, an indicator associated with the first data track indicating the sector of the first data track may be squeezed; causing, by the at least one processor, a write head to write to the second data track data to the corresponding sector of the second data track; and causing, by the at least one processor, data corresponding to the sector of the first data track that may be squeezed to be copied from the secondary write buffer and to another buffer.

In another example, the disclosure is directed to a storage device including a magnetic data storage device and at least one processor. The magnetic data storage device includes a write head and a plurality of data tracks. Each of the plurality of data tracks includes a respective plurality of data sectors. The at least one processor may be configured to, during writing of data to a second data track of a hard drive, determine, based on a position error signal (PES) for a sector of the second data track, whether the distance between the sector of the second data track and a corresponding sector of a first data track is less than a threshold distance. In one example, the second data track is adjacent to the first data track and the first data track stores previously written data. The at least one processor may also be configured to, in response to determining that the distance between the sector of the first data track and the corresponding sector of the second data track is less than the threshold distance, cause the write head to refrain from writing data to the corresponding sector of the second data track and set an indicator associated with the second data track indicating the data was not written to the corresponding sector of the second data track. The at least one processor may be further configured to, during writing of data to a fourth data track of the hard drive, determine, based on a PES for a sector of a third data track of the hard drive and a PES for a corresponding sector of the fourth data track, whether the distance between the sector of the third data track and the corresponding sector of the fourth data track is less than the threshold distance. In one example, the fourth data track is adjacent to the third track and the third data track stores previously written data. The at least one processor may be further configured to, in response to determining that the distance between the sector of the third data track and the corresponding sector of the fourth data track is less than the threshold distance, set an indicator associated with the third data track indicating the sector of the third data track may be squeezed and cause the write head to write data to the corresponding sector of the fourth data track.

In another example, the disclosure is directed to a storage device including a magnetic data storage device and at least one processor. The magnetic data storage device includes a write head and a plurality of data tracks. Each of the plurality of data tracks comprises a respective plurality of data sectors. The at least one processor may be configured to cause data from a first data track of the hard drive to be copied to a secondary write buffer. The at least one processor may also be configured to, during writing of data to a second data track of the hard drive, determine, based on a position error signal (PES) for a sector of the first data track and a PES for a corresponding sector of the second data track, whether the distance between the sector of the first data track and the corresponding sector of the second data track is less than a threshold distance. In one example, the second data track is adjacent to the first data track and the first data track stores previously written data. The at least one processor may be further configured to, in response to determining that the distance between the sector of the first data track and the corresponding sector of the second data track is less than the threshold distance, set an indicator associated with the first data track indicating the sector of the first data track that may be squeezed; cause a write head to write to the second data track data to the corresponding sector of the second data track; and cause data corresponding to the sector of the first data track that may be squeezed to be copied from the secondary write buffer and to another buffer.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual and schematic block diagram illustrating an example storage environment in which a storage device may interact with a host device, in accordance with one or more techniques of this disclosure.

FIG. 2 is a conceptual and schematic block diagram illustrating an example controller, in accordance with one or more techniques of this disclosure.

FIG. 3 is a flow diagram illustrating an example technique that at least one processor may implement for maintaining the integrity of data stored by a magnetic data storage device, in accordance with one or more techniques of this disclosure.

FIGS. 4A-4J are conceptual diagrams illustrating an example technique that at least one processor may implement for maintaining the integrity of data stored by a magnetic data storage device, in accordance with one or more techniques of this disclosure.

FIGS. 5A-5D are conceptual diagrams illustrating an example technique that at least one processor may implement for maintaining the integrity of data stored by a magnetic data storage device, in accordance with one or more techniques of this disclosure.

FIG. 6 is a flow diagram illustrating an example technique that at least one processor may implement for maintaining the integrity of data stored by a magnetic data storage device, in accordance with one or more techniques of this disclosure.

FIGS. 7A-7F are conceptual diagrams illustrating an example technique that at least one processor may implement for maintaining the integrity of data stored by a magnetic data storage device, in accordance with one or more techniques of this disclosure.

FIGS. 8A-8F are conceptual diagrams illustrating an example technique that at least one processor may implement for maintaining the integrity of data stored by a magnetic data storage device, in accordance with one or more techniques of this disclosure.

FIGS. 9A-9D are graphs illustrating example measurement results of a technique for maintaining the integrity of data stored by a magnetic data storage device, in accordance with one or more techniques of this disclosure.

### DETAILED DESCRIPTION

This disclosure describes systems and techniques for improving data integrity while writing to a Shingled Magnetic Recording (SMR) magnetic data storage device under external vibrations. In an SMR magnetic device, adjacent data tracks may partially overlap, which may increase a data track density, but also increase a likelihood that writing data to a later-written data track (a “second data track”) affects data stored on an adjacent, previously written data track (a “first data track”). The disclosure describes techniques for protecting data stored by the first data track during writing of data to the second data track, e.g., by not writing data to the second data track if the distance between the write head and the first data track is below a threshold distance value, or by indicating data in the first data track as potentially being affected by the writing of data to the second data track and maintaining or creating a copy of the indicated data in the first data track at a different location (e.g., a buffer or the like).

The described techniques may allow an SMR magnetic data storage device to increase the data track density (also referred to as “tracks-per-inch” or “TPI”) and maintain the integrity of data stored when the SMR magnetic data storage device experiences external vibrations. The described techniques may enable the SMR magnetic data storage device to determine whether writing data to a second data track is likely to corrupt or “squeeze” data written to a first data track. To determine whether writing data to the second data track is likely to “squeeze” data written to the first data tack, at least one processor may determine a respective position error signal (PES) value associated with the write head at a servo location associated with the sector of the first data track and at a servo location associated with the sector of the second, adjacent data track. The at least one processor may utilize these respective PES values to determine a PES distance, which is representative of a spacing between the position of the write head during the writing of data to the sector of the first data track and the position of the write head during the writing of data to the sector of the second, adjacent track.

The PES distance may indicate a likelihood that writing data to the second data track will affect data stored at the first data track. For example, under normal operating conditions (e.g., the storage device does not experience external vibrations), the PES distance may be relatively large for a servo location. The relatively large PES distance may indicate that the spacing between the position of the write head during the writing of data to the first data track and the position of the write head during the writing of data to the second track was relatively large, which may indicate a low likelihood that writing data to the second data track will affect data stored at the first data track.

Conversely, under certain conditions (e.g., the storage device experiences external vibrations), the PES distance may be relatively small for a servo location. The relatively small PES distance may indicate that the spacing between the position of the write head during the writing of data to the second data track and the position of the write head during the writing of data to the first data track was relatively small, which may indicate a higher likelihood that writing data to the second data track will affect data stored at the first data track.

In some examples, the at least one processor may compare the PES distance to a threshold PES distance. A PES distance below a predetermined threshold PES difference may indicate an increased likelihood that writing data to the second data track may affect data stored at the first data track. The at least one processor may determine the data on this first data track has an increased likelihood of the being affected based on the PES distance. The at least one processor may designate the first data track as a “squeezed” data track if the PES difference is less than the threshold PES distance.

In some examples, the at least one processor may be configured to determine respective PES values for at least one sector of the first and second data tracks and a corresponding PES distance for each servo location of the plurality of servo locations in the data track. The at least one processor may compare each respective PES distance to the threshold PES distance and determine whether each respective PES distance indicates that writing data to the second data track will “squeeze” the first data track at the respective servo location. In some examples, if the PES distance indicates that writing data to the second data track will squeeze the first data track, the at least one processor may cause a write head to refrain from writing data to the second data track (in other words, the sector is skipped) and may write the data corresponding to the skipped sector to a different location. In other examples, the at least one processor may cause data at the first data track to be copied to a buffer prior to causing the write head to write data to the second data track. By refraining from writing at least one sector of the second data track, or by copying data from the sector of the first data track that may be squeezed prior to writing the second data track, the hard drive may retain a valid copy of the data in the sector of the first data track.

In this way, the techniques described in this disclosure may maintain integrity of the data stored by the SMR magnetic data storage device. By detecting potentially squeezed sectors prior to writing data and refraining from writing or writing data to another location, the SMR magnetic data storage device may reduce the throughput degradation that may occur by attempting to rewrite data to the same sector repeatedly. In some examples, the described techniques may reduce write throughput under external vibration by about 40% to about 60% compared to full throughput with no rewrites. By reducing the write throughput loss, the techniques described herein may reduce the decrease in performance caused by re-locating data, while still allowing use of SMR magnetic media and the accompanying increase in tracks-per-inch and storage capacity SMR magnetic media provides.

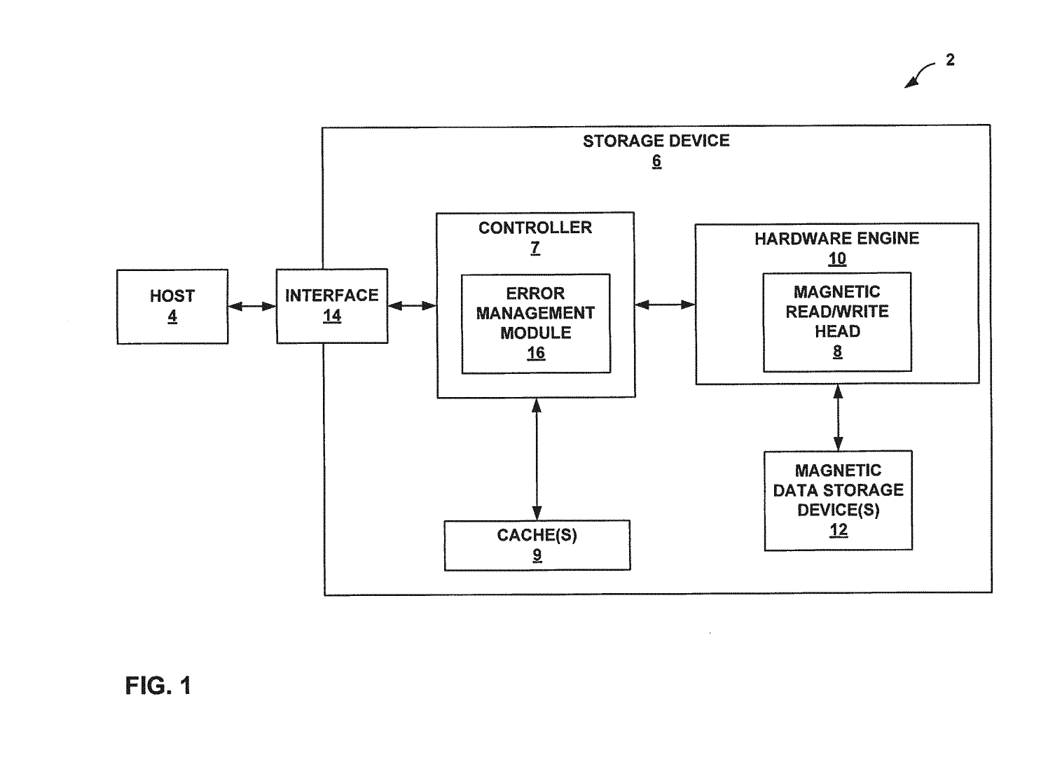

FIG. 1 is a conceptual and schematic block diagram illustrating an example storage environment 2 in which storage device 6 may interact with a host device 4, in accordance with one or more techniques of this disclosure. For instance, host device 4 may store data on or retrieve data from storage device 6. In some examples, storage environment 2 may include a plurality of storage devices, such as storage device 6, which may operate as a storage array. For instance, storage environment 2 may include a plurality of storage devices 6 configured as a redundant array of inexpensive/independent disks (RAID) that collectively function as a mass storage device for host device 4. While techniques of this disclosure generally refer to storage environment 2 and storage device 6, techniques described herein may be performed in any storage environment that utilizes tracks of data.

As illustrated in FIG. 1, host device 4 may communicate with storage device 6 via interface 14. Host device 4 may include any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like. Host device 4 may include any device having a processing unit, which may refer to any form of hardware capable of processing data and may include a general purpose processing unit (such as a central processing unit (CPU), dedicated hardware (such as an application specific integrated circuit (ASIC)), configurable hardware such as a field programmable gate array (FPGA) or any other form of processing unit configured by way of software instructions, microcode, firmware, or the like.

As illustrated in FIG. 1, storage device 6 may include an interface 14, a controller 7, a hardware engine 10, at least one cache 9, and at least one magnetic data storage device 12. Some examples of storage device 6 may include additional components not shown in FIG. 1 for ease of illustration. For example, storage device 6 may include power delivery components such as a capacitor, super capacitor, battery, or the like; a printed board (PB) to which at least some components of storage device 6 are mechanically attached and which includes electrically conductive traces that electrically interconnect components of storage device 6; or the like. In some examples, the physical dimensions and connector configurations of storage device 6 may conform to one or more standard form factors. Some example standard form factors may include 3.5″ hard disk drive (HDD), 2.5″ HDD, or 1.8″ HDD.

Storage device 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, interface 14 may operate in accordance with one or more of the following protocols: advanced technology attachment (ATA) (e.g., serial-ATA (SATA), and parallel-ATA (PATA)), Fibre Channel, small computer system interface (SCSI), serially attached SCSI (SAS), peripheral component interconnect (PCI), and PCI-express (PCIe). The electrical connection of interface 14 (e.g., the data bus, the control bus, or both) is electrically connected to controller 7, providing electrical connection between host device 4 and controller 7, allowing data to be exchanged between host device 4 and controller 7. In some examples, the electrical connection of interface 14 may also permit storage device 6 to receive power from host device 4.

Storage device 6 may include controller 7 to manage one or more operations of storage device 6. Controller 7 may interface with host device 4 via interface 14 and manage the storage of data to and the retrieval of data from magnetic data storage device 12 accessible via hardware engine 10. Controller 7 may, as one example, manage writes to and reads from the magnetic data storage device 12. In some examples, controller 7 may be a hardware controller. In other examples, controller 7 may be implemented into storage device 6 as a software controller. Controller 7 may further include one or more modules that perform techniques of this disclosure, such as error management module 16.

In the example of FIG. 1, storage device 6 includes hardware engine 10, which may represent the hardware responsible for interfacing with magnetic data storage device 12. Hardware engine 10 may, in the context of a platter-based hard disk drive, include the servo control, the magnetic read head or the magnetic read/write head. The read and write heads may be on the same head carrier (also called the read/write head 8). The head carrier may travel over the surface of the magnetic storage media in magnetic storage device 12 during operation. Although described in the following examples as being performed in the context of a hard disk drive, the techniques described in this disclosure may be extended to any type of hardware engine.

Storage device 6 may include at least one cache 9 that may be used as temporary data storage as a performance enhancement. Cache 9 may be used for read and write caching. In some examples, a write cache (also referred to as a write buffer) allows the drive to write data out to the disk media, such as magnetic data storage device 12, at some time after reporting to the host 6 that the write operation had been completed. Storage device 6 may report completion of the write command to the host 6 in response to the data to be written being transferred to the write buffer. This data may be protected provided power is not removed from the drive. In read caching, controller 7 may cause data to transfer from magnetic data storage device 12 to a read cache (also referred to as a read buffer), in anticipation that the data is data that host 6 may request next. In some examples, a single cache may be used as a write cache and a read cache. In some examples, cache 9 may be used to store information about the drive, such as PES values for one or more tracks of data.

In the example of FIG. 1, magnetic data storage device 12 may store information for processing during operation of storage device 6. For instance, storage device 6 may store data that controller 7 may access. In some examples, magnetic data storage device 12 represents a magnetic data storage disk.

The data in magnetic data storage device 12 may be stored in a plurality of annular tracks. The tracks may be divided into a plurality of data sectors. In some examples, each track includes hundreds or thousands of data sectors. The number of data tracks in magnetic data storage device 12 may be increased by decreasing the width of the tracks, decreasing the spacing between adjacent tracks, or both. The width of the tracks and spacing between adjacent tracks may be limited by the size (e.g., in the direction of the width of the track) of the read/write head of hardware engine 10.

In some examples of the techniques described herein, the tracks in magnetic data storage media 12 may use Shingled Magnetic Recording (SMR), also called Shingled Writing, to increase the tracks-per-inch. In SMR, the write head writes data to data tracks that partially overlap. The non-overlapped portions of adjacent data tracks form the shingled data tracks (SDT), which are narrower than the width of the write head. As the read head is narrower than the write head in the direction of the track width, the narrower read head data may read the data from the SDT.

Each data sector of an SDT may be preceded by a synchronization (sync) field, detectable by the read head, for enabling synchronization of reading and writing data to the data sectors. Also, each SDT may include a plurality of circumferentially or angularly-spaced servo locations that contain positioning information detectable by the read head for coordinating moving of the read/write head of hardware engine 10 to selected positions of the SDTs and maintaining the read/write head over the SDTs during the read and write operations. This pre-written servo pattern may be written during manufacturing process and data sectors may be allocated among these servo patterns during a write operation.

Because adjacent SDTs overlap, writing data to a second, later written track may, in some examples, affect data stored by a first, adjacent track to which data was previously written. In particular, if magnetic data storage device 12 experiences external vibrations while attempting to write data, external vibrations may cause write head 8 to shift position compared to a nominal position over the data track to which write head 8 is writing data. The position shift may include a shift closer to the first track at least some of the time, increasing a likelihood that data stored by the first track may be affected by writing of data to the second track. The reduced distance between the position of the write head 8 and the first data track may be referred to as a “squeeze.”

Error management module (EMM) 16 may be configured to detect external vibrations affecting of storage device 6 and determine whether writing data to a sector of the second data track is likely to squeeze a corresponding sector of the first data track. In some examples, storage device 6 may include sensors to detect external vibrations (e.g., one or more accelerometers, one or more gyroscopes, or the like). For example, EMM 16 may receive a signal from a sensor and determine that storage device 6 is experiencing external vibrations based on the signal received from the sensor. In some examples, EMM 16 may be configured to enable the technique of determining whether writing data to a sector of the second data track is likely to squeeze a corresponding sector of the first data track in response to detecting external vibrations. In other examples, EMM 16 may be configured to determine whether writing data to a sector of the second data track is likely to squeeze a corresponding sector of the first data track regardless of whether storage device 6 is experiencing external vibrations.

In some instances, EMM 16 may determine whether writing to the sector of the second data track is likely to squeeze a corresponding (adjacent) sector of the first data track based on a PES value associated with the sector of the second data track and, optionally, a PES value associated with the corresponding sector of the first data track. The PES values may indicate a position of write head 8 of hardware engine 10 over magnetic data storage device 12 as write head 8 passes over the servo location, and, in some examples, may refer to a relative offset of the position from the radial center of the respective track.

In some examples, EMM 16 may determine the respective PES values for the respective sectors of the first data track, which may include previously written data. For example, EMM 16 may determine the respective PES values as write head 8 writes data to the first data track. In some examples, EMM 16 may cause the PES values for the sectors of the first data track to be stored in a PES buffer. In this way, EMM 16 may determine the PES values by reading the PES values from the PES buffer without causing read/write head 8 to re-pass over the first track. In some examples, EMM 16 may cause the PES values for the first data track to be stored in non-volatile memory. As a result, the PES values for the first data track may be retained in the event that power is lost and the PES values may be copied from the non-volatile memory to the PES buffer once power is restored.

In some examples, controller 7 may initiate a first write operation to write at least a portion of data stored at a write buffer to a second data track of magnetic data storage device 12. During the first write operation, EMM 16 may determine a PES value associated with a particular sector of the second data track. EMM 16 may cause the PES value associated with the particular sector of the second data track to be stored in the PES buffer.

During the first write operation, EMM 16 may, in some examples, determine whether to cause write head 8 to write data to the particular sector based on the PES value associated with the sector of the second data track and, optionally, the PES value associated with the corresponding sector of the first data track. For example, EMM 16 may determine a PES distance based on the PES value associated with the sector of the second data track and the PES value associated with the corresponding sector of the first data track. The PES distance may be representative of spacing between the position of the write head during the writing of data to the first track and the position of the write head during the writing of data to the second, adjacent track.

EMM 16 may determine whether to cause write head 8 to write data to a particular sector of the second data track by comparing the PES distance to a threshold PES distance. The threshold PES distance may depend on the structure, track spacing, material or other characteristics of magnetic data storage device 12. The threshold PES distance may be selected to be a value below which a PES distance indicates a relatively high likelihood that writing data to the sector of the second track will affect the data in a corresponding sector of the first data track. For example, if the PES distance is less than a threshold PES distance, this indicates the write head may come sufficiently close to the first track while writing data to the second track that writing data to the second track is likely to affect data stored by the first data track. Thus, if EMM 16 determines that the PES distance is less than the threshold PES distance, EMM 16 may determine that writing data to the sector of the second data track will likely “squeeze” the corresponding sector of the first data track (which may be due to storage device 6 experiencing external vibrations).

As another example, EMM 16 may determine whether to cause write head 8 to write data to the particular sector based on the PES value associated with the sector of the second data track and a threshold PES value. The threshold PES value may be set to be a value below which it is likely that the writing of data to the sector of the second data track will likely “squeeze” the sector of the first data track.

As a result of the comparison, in some examples, EMM 16 may cause write head 8 to refrain from writing data to the sector of the second data track and may set an indicator indicating data was not written to the sector of the second data track. For example, the indicator may indicate data was not written to the second data tack by identifying the data from the write buffer that was not written to the sector of the second data track. In some examples, the indicator may indicate the unwritten sector is invalid. EMM 16 may cause the data that was not written to the sector of the second data track to be written to a subsequent data track or to another storage device. In this way, EMM 16 may avoid squeezing existing data on the first data track, while still writing the data for the sector of the second data track to a later track.

In some examples, instead of causing write head 8 to refrain from writing data to the sector of the second data track, if EMM 16 determines that writing data to the sector of the second data track will likely squeeze data in a corresponding sector of the first data track, EMM 16 may cause write head 8 to write data to the sector of the second data track and may set an indicator indicating the data stored at the corresponding sector of the first data track may be squeezed. For example, the indicator may indicate the sector of the first data track is invalid. In some examples, the indicator may identify a copy of the data corresponding to the potentially squeezed sector of the first data track. For example, prior to writing data to the sector of the second data track, EMM 16 may cause data from the first data track to be copied to a secondary write buffer. If EMM 16 determines that writing the data to a sector of the second data track will likely squeeze the corresponding sector of the first data track, the indicator may identify a copy of the potentially squeezed data in the secondary write buffer. In some examples, EMM 16 may cause the copy corresponding to the squeezed data to be copied from the secondary write buffer to the write buffer. Once the copy corresponding to the potentially squeezed data is copied to the write buffer, EMM 16 may cause the data from the write buffer to be written to a non-volatile memory device such as magnetic data storage device 12. For example EMM 16 may cause write head 8 to write the data from the write buffer to the end of the second data track, or to a third, different data track. In this way, EMM 16 may help ensure that magnetic data storage device 12 maintains a valid copy of all of the data that previously existed on magnetic data storage device 12 and the data received from host device 4 during writing of data to magnetic data storage device 12.

Upon completion of writing data to the second data track, controller 7 may cause write head 8 to write data to a third data track that is adjacent to the second data track as part of the first write operation, or may initiate a second write operation to cause write head 8 to write data to the third data, adjacent data track after writing data to the second data track. During the writing of data to the third, adjacent data track, EMM 16 may, in some examples, determine whether writing data to the third, adjacent data track is likely to squeeze an adjacent sector of the second data track. For example, during writing of data to the third data track, EMM 16 may determine the PES values for the third data track and store the PES values for the third data track to the PES buffer. EMM 16 may determine whether the PES distance between the sector of the third data track and a corresponding (adjacent) sector of the second data track is less than a threshold distance. If the PES distance between the sector of the third data track and the corresponding sector of the second data track is less than a threshold distance, EMM 16 may determine that writing data to the sector of the third data track will likely squeeze the corresponding sector of the second data track (e.g., due to storage device 6 experiencing external vibrations). As a result, in some examples, EMM 16 may cause write head 8 to refrain from writing data to the sector in the third data track and may set an indicator indicating that the data was not written. In other examples, EMM 16 may cause write head 8 to write the data to the particular sector of the third data track and may set an indicator indicating that the data stored at the corresponding (adjacent) sector of the second data track may be corrupt or squeezed.

Controller 7 may initiate additional write operations or continue writing data to additional data tracks. During each additional write operation or write to additional data tracks, controller 7 may cause write head 8 to write data to subsequent tracks until all of the data in the write buffer has been written to magnetic data storage device 12 and/or has been skipped over. Once all of the data has been written or skipped, EMM 16 may cause data corresponding to the skipped sectors and the squeezed sectors to be written to a non-volatile memory device. For example, EMM 16 may cause write head 8 to attempt to write data corresponding to the skipped or squeezed sectors to another portion of magnetic data storage device 12 (e.g., a fourth data track in an SMR portion of device 12 or a non-shingled portion of device 12). In some examples, EMM 16 may cause data corresponding to the skipped or squeezed sectors to be written to a secondary non-volatile storage area (e.g., flash memory) until EMM 16 determines that the drive is no longer experiencing external vibrations. Upon determining that the drive is no longer experiencing external vibrations, EMM 16 may cause the data to be copied from the non-volatile storage area to a fourth data track of magnetic data storage device 12.

The techniques described in this disclosure may enable storage device 6 to maintain data integrity by determining whether writing new data will likely squeeze existing data and writing the new or existing data to another portion of storage device 6. Additionally or alternatively, the techniques may reduce the number of write attempts that may otherwise occur if storage device 6 repeatedly attempts to re-write data to a particular sector, which may decrease throughput loss while still increasing the number of tracks-per-inch of storage device 6.

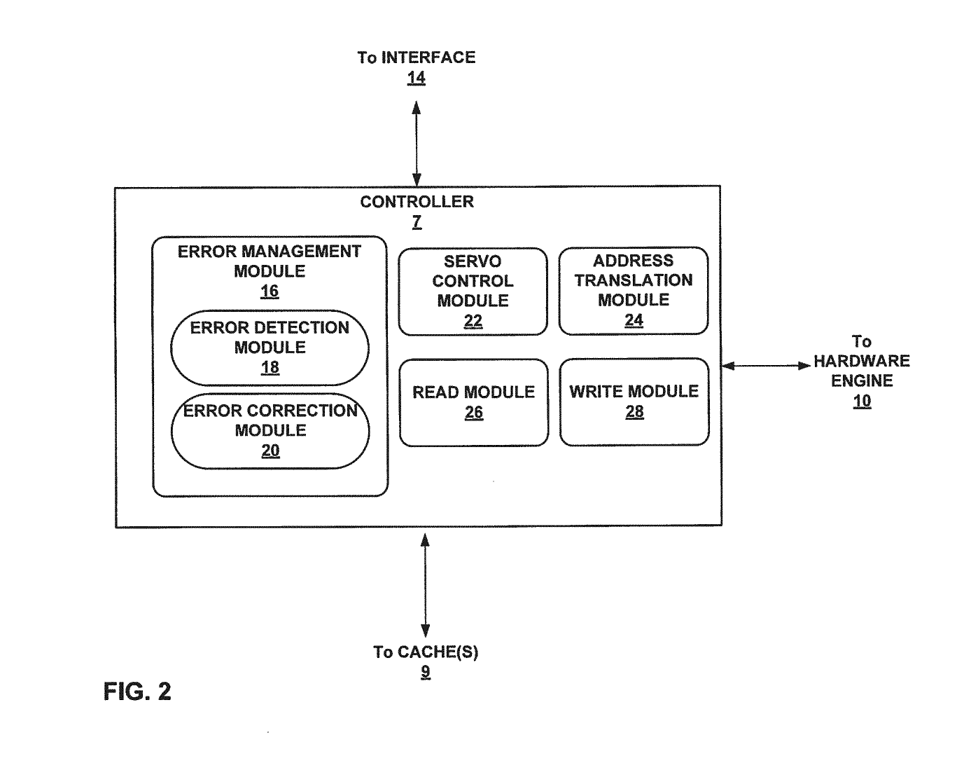

FIG. 2 is a conceptual and schematic block diagram illustrating a more detailed view of an example controller 7, in accordance with one or more techniques of this disclosure. In some examples, controller 7 may include error management module (EMM) 16, a servo control module 22, an address translation module 24, a read module 26, and a write module 28. In other examples, controller 7 may include more or fewer modules. Controller 7 may include a microprocessor, digital signal processor (DSP), application specific integrated circuit (ASIC), field programmable gate array (FPGA), or other digital logic circuitry. In some examples, controller 7 may be a system on a chip (SoC).

Controller 7 may interface with the host device 4 via interface 14 and manage the storage of data to and the retrieval of data from a magnetic data storage device 12. For example, write module 28 of controller 7 may receive a message from host device 4 via interface 14 instructing storage device 6 to store data associated with a logical address and the data and may manage writes to the magnetic data storage device 12 and the temporary storage in cache 9.

In some examples, write module 28 may communicate with address translation module 24. Address translation module 24 may manage translation between logical addresses, sometimes called logical block addresses (LBA) and physical addresses, sometimes called physical block addresses (PBA). Host device 4 may use LBAs to manage storage locations of data while write module 28 may use physical block addresses to direct writing of data to magnetic data storage device 12. Address translation module 24 of controller 7 may utilize a translation layer or table that translates logical addresses of data stored by magnetic data storage device 12 to physical addresses of data stored by magnetic data storage device 12. For example, host device 4 may utilize the logical addresses of the data stored by magnetic data storage device 12 in instructions or messages to storage device 6, while write module 28 utilizes physical addresses of the data to control writing of data to magnetic data storage device 12. The physical addresses may correspond to actual, physical location of the data on magnetic data storage device 12.

Read module 26 may control reading of data from magnetic data storage device 12 and temporary storage in cache 9. For example, read module 26 may receive a message from host device 4 requesting data with an associated logical block address. Address translation module 24 may convert the LBA to a physical address using the translation layer or table. Read module 26 then may control a read channel 12 to retrieve the data from a physical block addresses via hardware engine 10.

In the example of FIG. 2, servo control module 22 may control the physical position of the read/write head, which in some examples is part of hardware engine 10. Servo control module 22 may control hardware engine 10 to move the read/write head to the physical address required to retrieve data requested by read channel 12. Similarly, servo control module 22 may control hardware engine 10 to move the read/write head to a location requested by write module 28 to write data to magnetic data storage device 12. Servo control module 22 may track the physical position of the read/write head relative to magnetic data storage device 12 in order to determine the PES, or may communicate a signal indicative of the physical position of the read/write head to EMM 16 for use in determining the PES. While shown as included in controller 7, in some examples servo control module 22 may be included in a read channel, such that servo control module 22 may determine the PES values and the read channel may send a signal indicative of the PES values to controller 7.

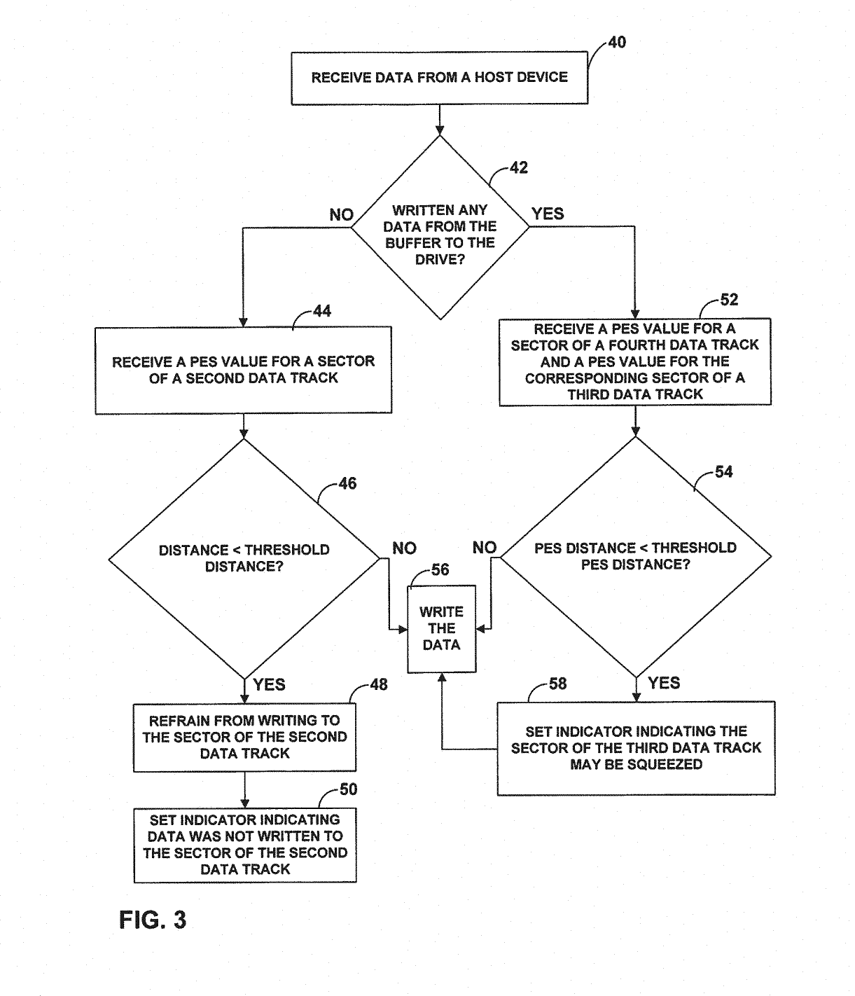

EMM 16 may include error detection module 18 and error correction module 20. In some examples, error detection module 18 may detect external vibrations affecting storage device 6, and also may determine whether writing data to a second data track is likely to affect or “squeeze” pre-existing data at an adjacent, first data track. In response to detecting that writing data to the second data track is likely to affect data at the first data track, error detection module 18 may take action to preserve the pre-existing data written to the first data track. For example, error detection module 18 may cause write head 8 to refrain from writing data to a sector of the second data track if writing data to that sector is likely to squeeze a corresponding adjacent sector of the first track. Error detection module 18 may set an indicator indicating the data was not written at the sector of the second data track. Error correction module 20 may write or cause write head 8 to write the data that was not written at the sector of the second data track to another location. In some examples, error correction module 20 may take action to preserve the pre-existing data written to the first data track by causing a copy of the data at the first data track to be written to another location prior to writing data to a portion of the second data track. Further details regarding operation of controller 7, including EMM 16, error detection module 18, and error correction module 20 will be described below with reference to FIGS. 3-8.

FIG. 3 is a flow diagram illustrating an example technique that at least one processor may implement for maintaining the integrity of data stored by a magnetic data storage device, in accordance with one or more techniques of this disclosure. Various components and modules (e.g., error management module 16) of storage device 6 may perform the techniques described in this disclosure. The technique of FIG. 3 will be described with respect to storage environment 2 of FIG. 1 and controller 7 of FIGS. 1 and 2 for purposes of illustration. However, it will be understood that the technique of FIG. 3 may be performed by a different processor or in a different storage environment, and that controller 7 and storage environment 2 may perform other techniques.

Controller 7 may receive a write command from host device 4 via interface 14 (40). The write command may include data and at least one LBA indicating the logical address with which the data is associated. In some examples, controller 7 may receive the write command and cause the data to be stored in a cache 9, such as a write buffer.

In response to receiving data from host device 4, controller 7 may determine whether write head 8 has written any of the data in the write buffer to magnetic data storage device 12 (42) and may cause write head 8 of hardware engine 10 to perform write operations to magnetic data storage device 12. For example, after receiving a write command from host 8, controller 7 may determine that none of the data received as part of the write command has been written from the write buffer to magnetic data storage device 12. As a result, controller 7 may begin a first write operation. In some examples, magnetic data storage device 12 includes pre-existing data at a first data track from a previous write operation. Thus, during a first write operation for the newly received write command, write module 28 may determine a subset of data in the write buffer to write to a second data track of magnetic data storage device 12.

During the first write operation, error detection module (EDM) 18 may determine whether writing data to a sector of the second data track is likely to squeeze data stored at a corresponding sector of the first data track. In some examples, EDM 18 may base this determination at least in part on whether storage device 6 is experiencing external vibrations at the time of the first write operation. Additionally or alternatively, EDM 18 may base the determination at least in part on a PES value associated with the sector of the second data track and/or a PES value associated with the corresponding (adjacent) sector of the first, adjacent data track. Controller 7 may determine a PES value associated with a sector of the second data track (44). In some examples, controller 7 may also determine a PES value associated with a corresponding sector of the first, adjacent data track. In some examples, servo control module 22 may track the physical position of the read/write head relative to magnetic data storage device 12 in order to determine the PES value associate with the sector of the second data track and/or the PES value of the corresponding adjacent sector of the first data track. However, in some examples, servo control module 22 may communicate a signal indicative of the physical position of the read/write head to EDM 18 for use in determining the PES values for the respective sectors.

In some examples, EDM 18 may determine whether the distance between a sector of the second data track and a corresponding sector of the first data track is less than a threshold distance (46). For example, EDM 18 may determine whether the PES value associated with the sector of the second data track is less than a threshold value. In another example, EDM 18 may determine a PES distance and determine whether the PES distance is less than a threshold PES distance. For instance, EDM 18 may determine a PES distance based on the PES value associated with the sector of the second data track and the PES value associated with the corresponding sector of the first data track. A distance less than the threshold distance may indicate that writing data to the second data track is likely to squeeze data in the first data track, and may be caused by storage device 6 experiencing external vibrations. If the distance is greater than or equal to the threshold distance, this may indicate that writing data to the second data track is unlikely (or less likely) to affect data in the first data track. As a result, EMM 16 may cause write head 8 to write data to the second data track (56).

In some examples, if the PES distance is less than a threshold PES distance, EDM 18 may cause write head 8 to refrain from writing data to the sector of the second data track (48). Further, EDM 18 may set an indicator indicating data was not written to the second data track (50). In some examples, the indicator may indicate data was not written to the second data track by identifying a portion of data in the write buffer was not written to the second data track. For example, the indicator may include a write buffer address to identify the data from the write buffer that was not written to the sector of the second data track. In some examples, EDM 18 may set the indicator indicating the data was not written by setting the unwritten sector to an invalid state (e.g., by updating an “invalid” flag). Error correction module (ECM) 20 may cause the data that was not written to the sector of the second data track to be written to a subsequent data track or to another storage device. As a result, EMM 16 may cause the received data to be written to magnetic data storage device 12 and may avoid squeezing existing data on the first data track.

In some examples, after writing data to the second data track, storage device 6 may release the portion of the write buffer corresponding to the written data such that the portion of the write buffer may be used to store additional data as it is received from the host. However, in some examples, storage device 6 may store the data in the write buffer until write head 8 has finished writing all of the data associated with the write command.

Controller 7 may cause write head 8 to write data to subsequent data tracks, such as a third data track, a fourth data track, etc. Controller 7 may cause write head 8 to write to a fourth data track as part of the first write operation, or may initiate a second write operation to cause write head 8 to write data to the fourth data track. Write module 28 may determine a second subset of data from the write buffer to cause write head 8 to write to a fourth data track.

During writing to the fourth data track, EDM 18 may determine whether writing data to a sector of the fourth data track is likely to squeeze data stored at a corresponding sector of the third, adjacent data track (which may indicate external vibrations) based on a PES value associated with the sector of the fourth data track and a PES value associated with the corresponding sector of the third data track. Servo control module 22 or EDM 18 may receive the PES value associated with the sector of the fourth data track and the PES value associated with the corresponding adjacent sector of the third data track (52). Controller 7 may determine a PES distance based on the PES value associated with the sector of the fourth data track and the PES value associated with the corresponding sector of the third data track (54). In response to determining that the PES distance is greater than a threshold PES distance, EDM 18 may cause write head 8 to write a portion of the data to the sector of the fourth data track (56).

In some examples, in response to determining that the PES distance is less than the threshold PES distance, EDM 18 may cause write head 8 to refrain from writing to the sector of the fourth data track. However, in some examples, EDM 18 may cause write head 8 to write to the sector of the fourth data track and may set an indicator indicating the sector of the third data track may be squeezed. In some examples, the indicator may indicate a portion of data in the write buffer that corresponds to the potentially squeezed sector of the third data track (58). For example, the indicator may include a write buffer address that specifies data in the write buffer that was written to the potentially squeezed sector of the third track. ECM 20 may cause data corresponding to the potentially squeezed sector to be written to a subsequent data track or to another storage device.

Write module 28 may determine additional subsets of data to write at subsequent data tracks using the techniques described above. EDM 18 may determine whether writing data to the subsequent data tracks is likely to squeeze the previously written data tracks. In response to determining that writing to the subsequent data tracks is likely to squeeze a previously written data track, EDM 18 may cause write head 8 to refrain from writing to a sector of the subsequent track, or may set an indicator that indicates data in the write buffer to be re-written to another location. In this way, EMM 16 may cause all of the data in the write buffer to be written to the storage device 6 without losing data that may be corrupted or squeezed by writing subsequent data.

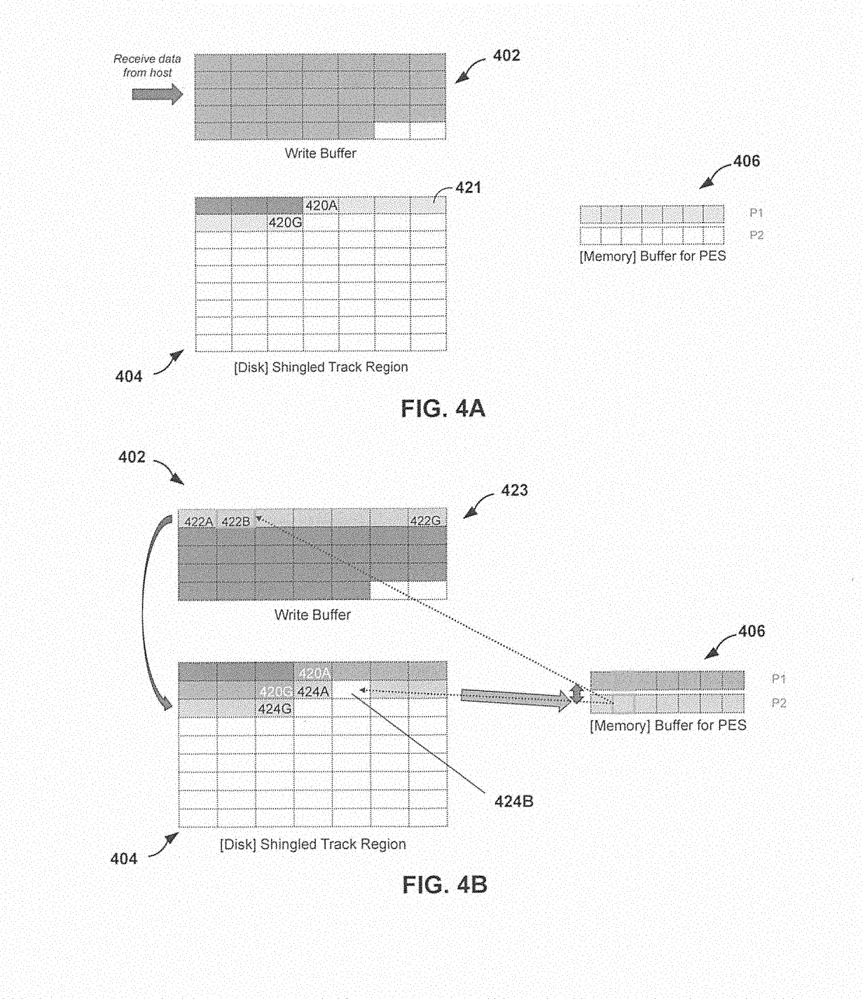

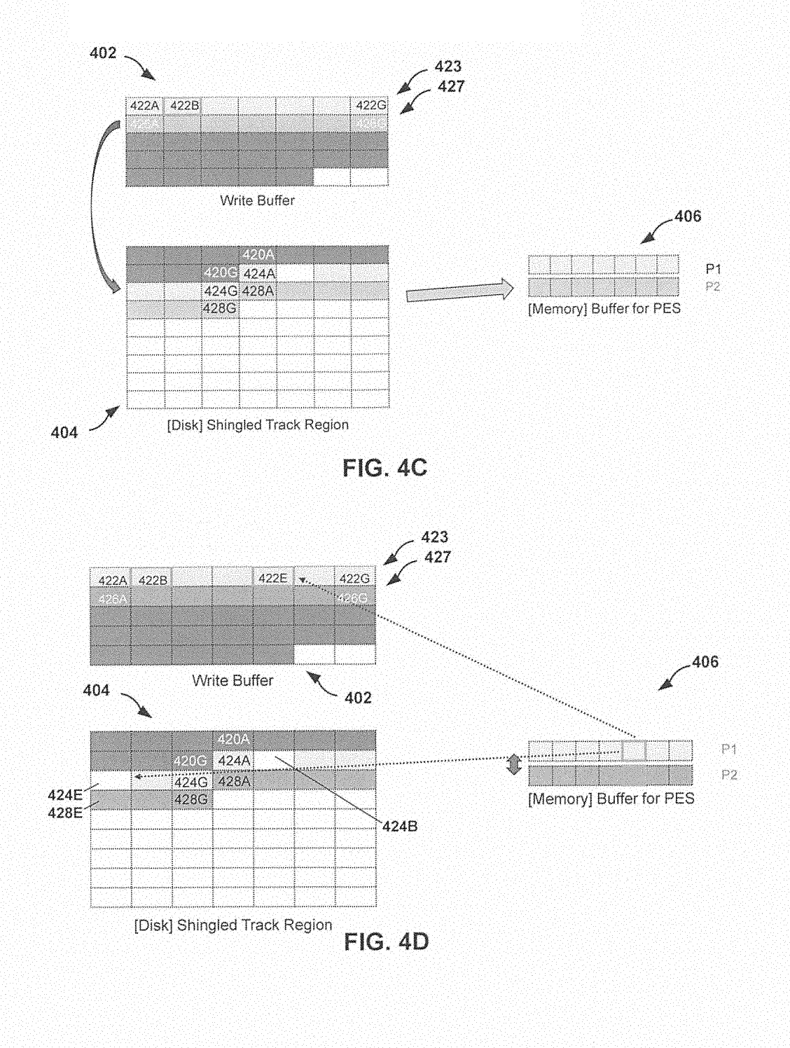

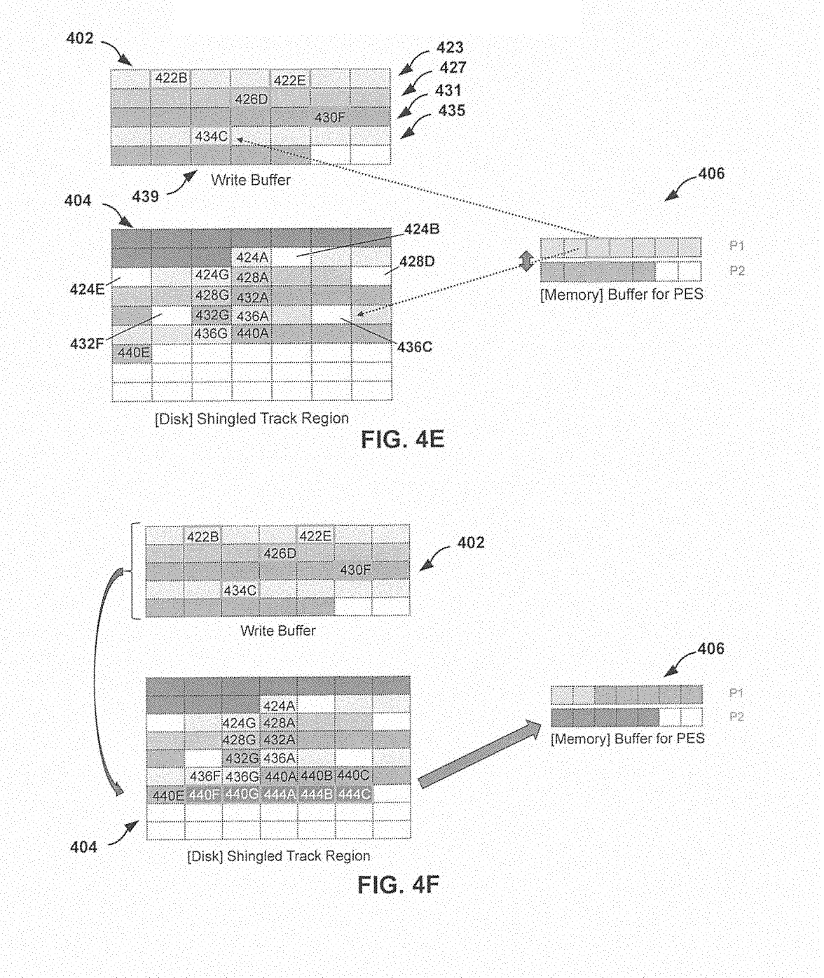

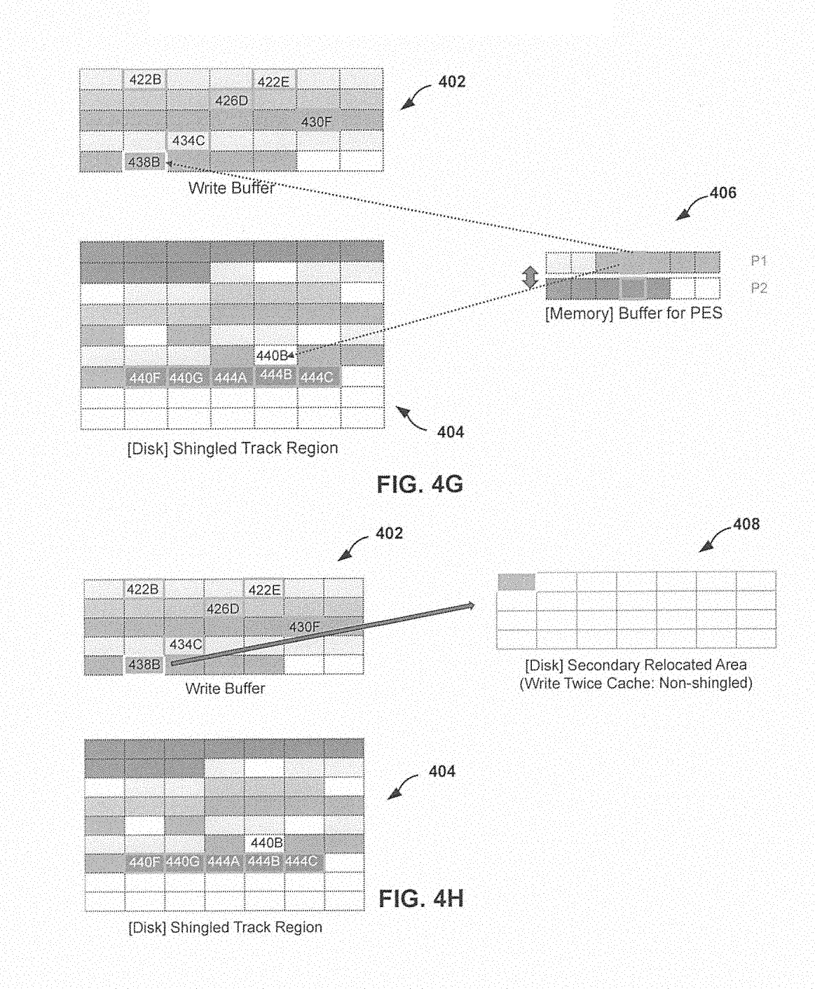

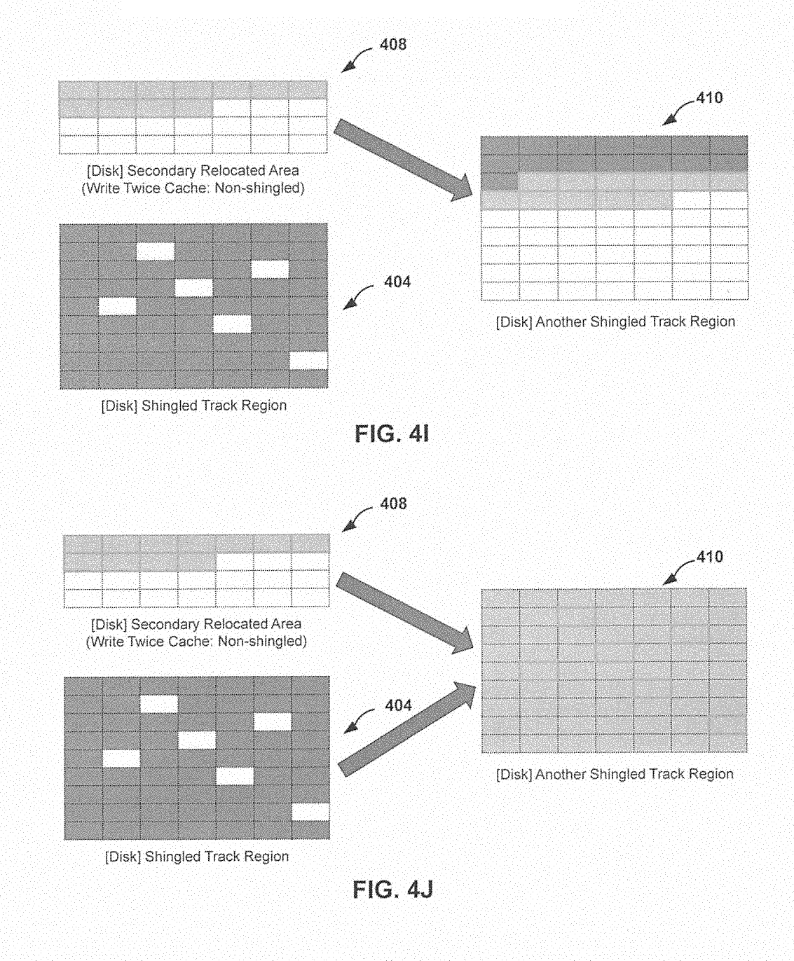

FIGS. 4A-4J are conceptual diagrams illustrating an example technique that at least one processor may implement for maintaining the integrity of data stored by a magnetic data storage device, in accordance with one or more techniques of this disclosure. For purposes of illustration, the technique will be described with reference to the flow diagram of FIG. 3 and with respect to storage environment 2 of FIG. 1 and controller 7 of FIGS. 1 and 2. However, it will be understood that the technique of FIGS. 4A-4J may include additional or fewer steps.

With reference to FIG. 4A, in some examples, storage device 6 may include one or more magnetic data storage devices 12. Magnetic data storage device 12 may include a non-shingled track region and a shingled track region 404. Shingled track region 404 includes a plurality of data tracks, and each track includes a plurality of sectors. Shingled track region 404 may include pre-existing data at a first data track. As used throughout this disclosure, the term “data track” may refer to a plurality of sectors that are not necessarily the same radial distance from the center of a disk platter. Rather, one or more sectors of the data track may be a first radial distance from the center of the disk platter and one or more sectors of the data track may be a second radial distance from the center of the disk platter. For example and for purposes of illustration only, in FIG. 4A, the first data track 420 is defined by sectors 420A-420G, as shown by shaded region 421. For ease of illustration, only sectors 420A and 420G are explicitly labeled. However, it is to be understood that labels for other sectors may be inferred and that first data track 420 includes sectors 420A, 420B, 420C, 420D, 420E, 420F, and 420G. For ease of illustration only, shingled track region 404 is shown with seven sectors per data track. However, it is to be understood that each track of shingled track region 404 may include any number of sectors.

Storage device 6 may include one or more cache devices 9, such as write buffer 402 and PES buffer 406. In some examples, write buffer 402 and PES buffer 406 may be part of the same physical cache 9, or may be independent cache devices. Write buffer 402 may temporarily store data received from host device 4. PES buffer 406 may store PES values associated with data tracks of shingled track region 404. In some examples, PES buffer 406 may include two or more buffer regions, such as PES buffer region P1 and PES buffer region P2. PES buffer region P1 may store PES values associated with a first data track of shingled track region 404 and a PES buffer region P2 may store PES values associated with a second data track of shingled track region 404. In some examples, PES buffer region P1 may store PES values associated with one or more sectors of data previously written at first data track 420.

With further reference to FIG. 4A, storage device 6 may receive a write command and data from host device 4. In some examples, controller 7 may receive the write command and cause the data to be stored in write buffer 402.

In response to receiving the write command and data from host device 4, controller 7 may initiate a first write operation associated with the received write command, as illustrated in FIG. 4B. During the first write operation, write module 28 may determine a first subset of data, defined by sections 422A-422G, as shown by shaded region 423, to write to a second data track of shingled track region 404. For purposes of illustration only, second data track 424 is defined by sectors 424A-424G.

During the first write operation, controller 7 may determine a PES value associated with a first sector of second data track 424 (e.g., sector 424A) and a corresponding sector of adjacent, first data track 420 (e.g., sector 420A). As described above, servo control module 22 may track the physical position of the read/write head and determine the PES value associated with sector 424A, or servo control module 22 may communicate a signal indicative of the physical position of the read/write head to EDM 18 for use in determining the PES value associated with sector 424A. EDM 18 may cause the PES value associated with sector 424A to be stored to PES buffer region P2. In some examples, EDM 18 may determine the PES value associated with sector 420A by retrieving the value from PES buffer region P1.

EDM 18 may determine whether writing data to sector 424A of second data track 424 is likely to squeeze data stored at a corresponding sector 420A of the first data track 420 (which may occur if storage device 6 experiences external vibrations) based on the PES values associated with the respective sectors. For example, EDM 18 may determine a PES distance based on the PES values and determine whether the PES distance is less than a threshold PES distance. A PES distance greater than a threshold PES distance may indicate that writing data to sector 424A is not likely to squeeze data stored at sector 420A. In response to determining that the PES distance associated with sectors 424A and 420A is greater than the threshold PES distance, as illustrated in FIG. 4B, controller 7 may cause write head 8 to write data to sector 424A of second track 424 and to move to the next sector of second data track 424 (e.g., sector 424B).

In response to the write head moving to sector 424B, controller 7 may determine the PES value associated with sector 424B and may store the PES value in PES buffer region P2. EDM 18 may retrieve the PES value associated with sector 420B of the first data track from PES buffer region P1. EDM 18 may determine whether writing data to sector 424B of second data track 424 is likely to squeeze sector 420B of adjacent, first data track 420 by determining a PES distance associated with the PES values associated with sectors 424B and 420B, respectively. A PES distance less than the threshold PES distance may indicate that writing data to sector 424B is likely to affect, or “squeeze”, data stored at sector 420B. In some examples, if EDM 18 determines that the PES distance associated with sectors 424B and 420B is less than the threshold PES distance, as illustrated in FIG. 4B, controller 7 may cause write head 8 to refrain from writing data to sector 424B of second data track 424. As a result, controller 7 may cause write head 8 to move to the next sector of second data track 424 (e.g., sector 424C).

In some examples, EDM 18 may set an indicator indicating that data that was not written to sector 424B. For example, the indicator may specify a write buffer address or range of write buffer addresses corresponding to the data that was not written sector 424B. In some examples, EDM 18 may set an indicator indicating that sector 420B is invalid.

For each of the subsequent sectors of second data track 424 (e.g., sectors 424C-424G), controller 7 may determine the PES value associated with the respective sector of second data track 424 and the PES value associated with a corresponding sector of first, adjacent data track 420. For each sector of second data track 424, EDM 18 may determine whether writing data to the respective sector is likely to squeeze data in the corresponding sector of first data track 420 based on a PES distance associated with the sector of second data track 424 and the corresponding sector of first data track 420. In some examples, if EDM 18 determines that the PES distance is less than a threshold PES distance, EDM 18 may cause write head 8 to refrain from writing to the sector of second data track 424, set an indicator indicating the data corresponding to the sector that was not written (also referred to as a skipped sector) and move to the next sector of second data track 424. After EDM 18 has determined whether to write data to each of sectors 424A-424G of second data track 424, controller 7 may prepare to write data to a third data track that is adjacent to the second data track.

During preparing to write data to the third data track, controller 7 may cause the PES values associated with second data track 424 to be copied from PES buffer region P2 to PES buffer region P1 so that PES values associated with a third data track may be stored in PES buffer region P2. Write module 28 may determine a second subset of data, defined by regions 426A-426G, as shown by shaded region 427, to write to a third data track of shingled track region 404. For purposes of illustration only, third data track 428 is defined by sectors 428A-428G, as illustrated in FIG. 4C.

During writing to the third data track, EDM 18 may determine whether to write data to a sector of the third track based on a PES value associate with the particular sector of the third data track and a corresponding sector of the adjacent, second data track. However, in some examples, controller 7 may cause write head 8 to write data to the third data track regardless of the respective PES values. In either case, EDM 18 may determine the PES values for the respective sectors and determine whether writing data to third data track 428 is likely to squeeze data previously written at second data track 424. For example, controller 7 may determine a PES value associated with a first sector of third data track 428 (e.g., sector 428A) and a corresponding sector of adjacent, second data track 424 (e.g., sector 424A). EDM 18 may cause the PES value associated with sector 428 to be stored to PES buffer region P2. In some examples, EDM 18 may determine the PES value associated with sector 424A by retrieving the value from PES buffer region P1.

EDM 18 may determine a PES distance associated with sector 428A and sector 424A and determine whether the PES distance is less than a threshold distance. If the PES distance is greater than the threshold PES distance, EDM 18 may determine that writing data to a sector of the third data track is not likely to squeeze the corresponding sector of adjacent second data track 424. However, if the PES distance is less than the threshold PES distance, EDM 18 may determine whether writing data to a sector of third data track 428 will likely squeeze a sector of the second, adjacent data track. For example, EDM 18 may determine a PES distance associated with sectors 428E and 424E and determine that the PES distance is less than the threshold PES distance. Further, EDM 18 may set an indicator indicating the sector may be squeezed. For example, the indicator may identify data in write buffer 402 corresponding to the data stored at sector 424E. Because the data written to sector 424E still exists in write buffer 402, the indicator may specify a write buffer address, or a range of write buffer addresses, corresponding to the data at sector 424E. In some examples, EDM 18 may set the indicator by setting an invalid flag for sector 424E to be invalid and write module 28 may cause write head 8 to write data to sector 428E and move to sector 428F.

For the remaining sectors of third data track 428, EDM 18 may determine whether writing data to a particular sector is likely to squeeze a corresponding adjacent sector of second data track 424. If EDM 18 determines that writing data to a sector of third data track 428 is likely to squeeze a corresponding, adjacent sector of second data track 424, EDM 18 may set an indicator indicating the corresponding sector of the second data track is likely to be squeezed. In response to completing writing data to third data track, controller 7 may cause the PES values associated with sectors 428A-428G to be copied from PES buffer region P2 to PES buffer region P1 so that PES values associated with a subsequent data track may be stored in PES buffer region P2.

Controller 7 may determine additional subsets of data to write at subsequent data tracks of shingled track region 404. For instance, as shown in FIG. 4E, controller 7 may determine a third subset of data, as shown by shaded region 431, to write to a fourth data track 432 (defined by sectors 432A-432G); a fourth subset of data, as shown by shaded region 435, to write to a fifth data track 436 (defined by sectors 436A-436G); a fifth subset of data, as shown by shaded region 439, to write to at least a portion of a sixth data track 440 (defined by sectors 440A-440E). During writing the respective data tracks, EDM 18 may cause the PES values associated with each sector of the respective data track to be stored in PES buffer region P2. EDM 18 may continue to determine whether writing data to a sector of a subsequent track (e.g., sixth data track 440) is likely to squeeze data at a previously written track (e.g., fifth data track 436). If EDM 18 determines that writing the data to a subsequent track will squeeze previously written data, EDM 18 may set an indicator indicating the data stored at the sector of the previous track is likely to be squeezed (e.g., by specifying an address corresponding a copy of the data and/or by setting an invalid flag). After completing writing a particular data track, controller 7 may cause the PES values to be copied from PES buffer region P2 to PES buffer region P1 so that the PES values associated with the next data track may be stored in PES buffer region P1.

In summary, as illustrated by the example of FIG. 4E, EDM 18 may determine that writing data to sector 424B of second data track 424 will likely squeeze a corresponding adjacent sector of first data track 420, refrain from writing data to sector 424B, and set an indicator indicating that data at section 422B of write buffer was not written. Likewise, EDM 118 may determine that sectors 424E, 428D, 432F, and 436C are likely to be squeezed when subsequently writing the adjacent tracks. Further, EDM 18 may set an indicator indicating that data sections 422E, 426D, 430F, and 434C of write buffer 402 correspond to each of the respective potentially squeezed sectors.

ECM 20 may perform a data relocation operation after controller 7 has caused write head 8 to write to one or more data tracks. ECM 20 may determine a subset of data from write buffer 402 that includes the sections of data corresponding to the sectors of shingled track region 404 that were either skipped (i.e., not written) or likely to be squeezed, the subset of data being referred to as relocation data. As illustrated in FIG. 4F, the relocation data may include data from sections 422B, 422E, 426D, 430F, and 434C of write buffer 402. ECM 20 may cause the relocation data to be written to the next data track. In some examples, the relocation data may be written to a portion of the previous data track and at least a portion of the next data track. For example, ECM 20 may cause a portion of the relocation data to be written to the remaining sectors (e.g., sectors 440F and 440G) of the sixth data track and one or more sectors (e.g., sectors 444A-444C) of a seventh data track.

During the data relocation operation, EDM 18 may determine whether writing the relocation data is likely to squeeze any of the previously written data by determining whether a PES distance associated with a pair of sectors is less than a threshold PES distance. As described above, EDM 18 may determine a PES distance associated with a sector of the relocation data (e.g., one of sectors 440F-444C) and the corresponding sector of the previously written adjacent data track (e.g., sectors 436F-440C, respectively). If EDM 18 determines that the PES distance is greater than the threshold PES distance, EDM 18 may cause write head 8 to write the relocation data to the respective sectors. In some examples, EDM 18 may determine that the PES difference is less than a threshold PES distance. For example, as illustrated in FIG. 4G, the PES distance associated with sector 440B and sector 444B may be less than a threshold PES distance. As a result, EDM 18 may determine that the data stored at sector 440B is likely to be squeezed. In some examples, EDM 18 may determine that data at section 438B of write buffer 402 corresponds to section 440B and may cause data from section 438B to be re-written to a subsequent sector of shingled track region 404. In such an example, EDM 18 may determine whether writing data to a subsequent sector of shingled track region 404 is likely to squeeze a corresponding, adjacent sector. In some examples, controller 7 would continue this process until EDM 18 determines that writing data to a subsequent sector is not likely to squeeze previously written data at a corresponding, adjacent sector.

In some examples, rather than relocating data to shingled track region 404 for a second time, ECM 20 may cause data corresponding to the sector squeezed by the first relocation operation (e.g., sector 440B) to be relocated to a secondary relocation area 408, also referred to as a “write twice cache”. In some examples, secondary relocation area 408 may be a non-shingled storage area. For example, secondary relocation area 408 may be a non-shingled portion of magnetic data storage device 12 or a non-volatile memory device (e.g., flash memory).

Upon writing data to secondary relocation area 408, controller 7 may release the portion of write buffer 402 used to store data received as part of the write command so that said portion of write buffer 402 may be used to temporarily store data as storage device 6 receives additional write commands from host device 4. As storage device 6 receives additional write commands from host device 4, controller 7 may perform additional write operations and relocation operations. Controller 7 may cause additional data to be written to secondary relocation area 408.

As illustrated in FIG. 41, ECM 20 may determine whether to write data from the secondary relocation area 408 to a shingled track region (e.g., 410) of magnetic data storage device 12. In some examples, ECM 20 may determine whether to write the data to a shingled track region based the occupied portion of secondary relocation area 408. For example, ECM 20 may compare an occupied portion of secondary relocation area 408 (e.g., the number of sections containing data) to a threshold portion. In some examples, in response to determining that the occupied portion of secondary relocation area 408 is greater than the threshold portion, ECM 20 may cause write head 8 to copy the data from secondary relocation area 408 to a shingled portion of magnetic data storage device 12. For example, ECM 20 may cause write head 8 to write the data to another shingled track region 410. In some examples, during writing data from secondary relocation area 408 to a shingled track region, EDM 18 may determine whether writing data to a track is likely to squeeze a previously written adjacent data track, as described above.

As illustrated in FIG. 4J, in some examples, ECM 20 may cause write head 8 to perform a defragmentation operation. ECM 20 may determine an original write order for the data stored at shingled track region 404 and secondary relocation area 408. ECM 20 may cause write head 8 to write the data to another shingled track region 410 in the original write order. During the defragmentation operation, EDM 18 may determine whether writing data to a track of shingled track region 410 is likely to squeeze a previously written adjacent data track, as described above.

In some examples, storage device 6 may receive a read command from host device 4. The command may include a request for data at a particular LBA or set of LBAs. In response to receiving the read command, read module 26 may copy data from shingled track region 404 and/or secondary relocation area 408. For example, read module 26 may read relocation data from secondary relocation area 408 and may cause a copy of the relocation data to be stored in a read buffer. Similarly, read module 26 may cause a read head to read relocation data from shingled track region 404 and may cause a copy of the relocation data to be stored in the read buffer. Read module 26 may determine whether the relocation data copied to the read buffer is included in the LBA(s) requested by host device 4.

In some examples, read module 26 may cause the read head to read data from a particular data track of shingled track region 404 and may copy the data from the particular track of shingled track region 404 to the read buffer. Read module 26 may determine the original address information for the data copied to the read buffer in order to return the proper data to host device 4. In this way, read module 26 may determine the original address information and send the data back to host device 4 in the same order the data was originally received from host device 4. Read module 26 may cause the read head to read data from additional data tracks of shingled track region 404, copy the data to the read buffer, and determine the original address information as described above.

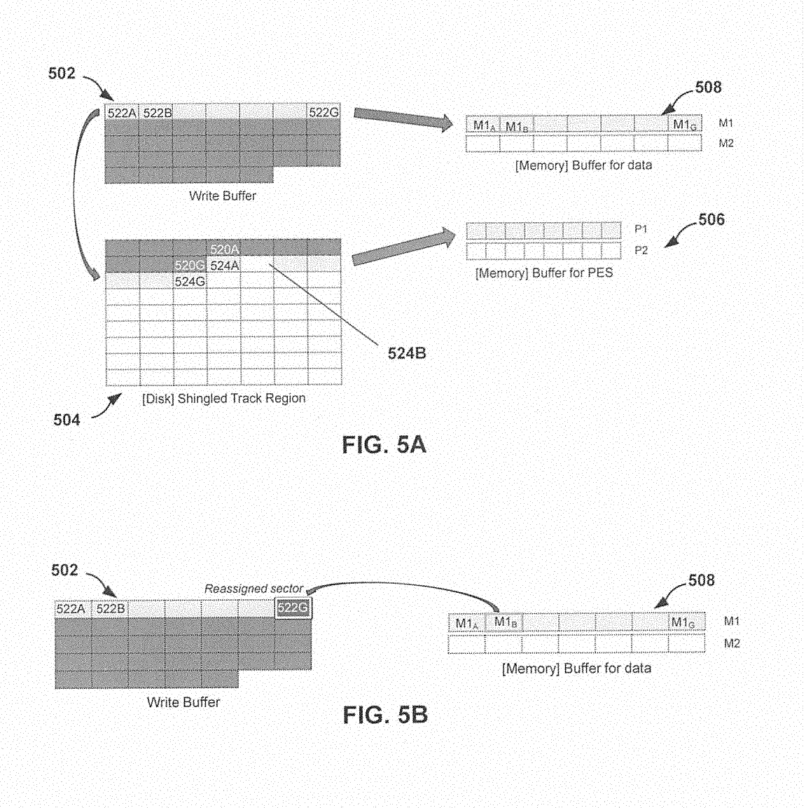

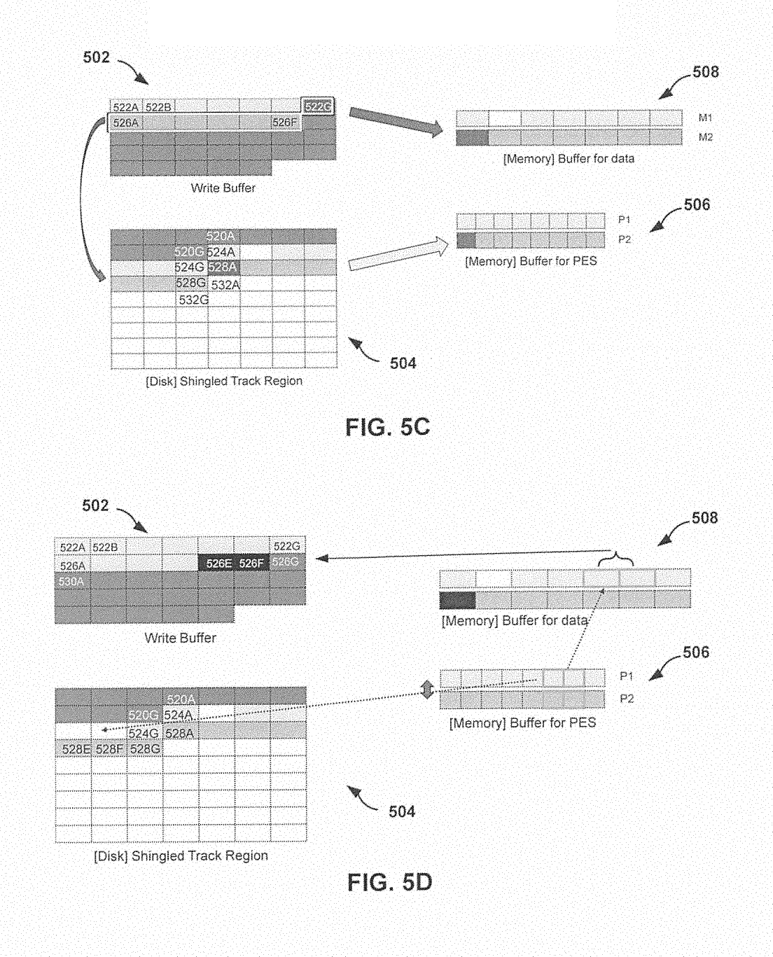

FIGS. 5A-5D are conceptual diagrams illustrating an example technique that at least one processor may implement for maintaining the integrity of data stored by a magnetic data storage device, in accordance with one or more techniques of this disclosure. For purposes of illustration, the technique will be described with reference to the flow diagram of FIG. 3 and with respect to storage environment 2 of FIG. 1 and controller 7 of FIGS. 1 and 2. However, it will be understood that the technique of FIGS. 5A-5C may include additional or fewer steps.

With reference to FIG. 5A, in some examples, storage device 6 may include one or more magnetic data storage devices 12. Magnetic data storage device 12 may include a shingled track region 504. Shingled track region 504 includes a plurality of data tracks, and each track includes a plurality of sectors. Shingled track region 504 may include pre-existing data at a first data track. For purposes of illustration only, in FIG. 5A, the first data track 520 is defined by sectors 520A-520G. For ease of illustration only, shingled track region 504 is shown with seven sectors per data track. However, it is to be understood that each track of shingled track region 504 may include any number of sectors.

Storage device 6 may include one or more cache devices 9, such as primary write buffer 502, PES buffer 506, and secondary write buffer 508. In some examples, primary write buffer 502, PES buffer 506, and/or secondary write buffer 508 may be part of the same physical cache 9, or may be independent cache devices. Primary write buffer 502 may temporarily store data received from host device 4. PES buffer 506 may store PES values associated with data tracks of shingled track region 504. In some examples, PES buffer 506 may include two or more buffer regions, such as PES buffer region P1 and PES buffer region P2. PES buffer region P1 may store PES values associated with a first data track of shingled track region 504 and PES buffer region P2 may store PES values associated with a second data track of shingled track region 504. PES buffer region P1 may store PES values associated with one or more sectors of the data previously written at first data track 520. In some examples, secondary write buffer 508 may include two or more buffer regions, such as secondary write buffer regions M1 and M2. For example, secondary write buffer region M1 may store a copy of data previously written to a first data track of shingled track region 504 and secondary write buffer region M2 may store a copy of data to be written to a second data track of shingled track region 504.

Storage device 6 may receive a write command and data from host device 4. In some examples, controller 7 may receive the write command and cause the data to be stored in primary write buffer 502.

In response to receiving the write command and data from host device 4, controller 7 may initiate a first write operation associated with the received write command, as illustrated in FIG. 5A. During the first write operation, write module 28 may determine a first subset of data, defined by regions 522A-522G, to write to a second data track of shingled track region 504. For purposes of illustration only, second data track 524 is defined by sectors 524A-524G. Controller 7 may cause the first subset of data to be copied from primary write buffer 502 to a portion of secondary write buffer 508, such as secondary write buffer region M1. In this way, controller 7 may retain a copy of the first subset of data.

In some examples, during writing to the second track, EDM 18 may determine whether to write to a sector of second data track 524 based on a PES value associated with the particular sector of second data track 524. Controller 7 may determine a PES value associated with the sector of second data track 524 and store the PES value at PES buffer region P1. For example, servo control module 22 may track the physical position of the read/write head and EDM 18 (or servo control module 22) may determine the PES value associated with sector 524A. EDM 18 may determine whether to write to a given sector of second data track 524 by comparing the PES value associated with sector 524A to a threshold PES value. For example, EDM 18 may determine whether the distance between sector 524A and a corresponding sector of first data track 520A is less than a threshold distance by determining whether the PES value associated with sector 524A is less than the threshold PES value. The threshold PES value may be set to be a value below which it is likely that the writing of data to the sector of the second data track will likely “squeeze” the sector of the first data track. If the PES value associated with sector 524A is less than the threshold PES value, EDM 18 may cause write head 8 to refrain from writing to sector 524A. As illustrated in FIG. 5A, if the PES value associated with sector 524A is greater than the threshold PES value, EDM 18 may cause write head 8 to write to sector 524A and move to the next sector of second data track 524 (e.g., sector 524B).

In response to the write head moving to sector 524B, controller 7 may determine the PES value associated with sector 524B and may store the PES value in PES buffer 506. EDM 18 may determine whether writing data to sector 524B of second data track 524 is likely to squeeze sector 520B of adjacent, first data track 520 based on the PES value associated with sector 524B, or in some examples, based on the PES values associated with sectors 524B and 520B, respectively. As illustrated in FIG. 5A, if EDM 18 determines that writing to sector 524B of second data track 524 is likely to squeeze corresponding sector 520B of first data track 520, controller 7 may cause write head 8 to refrain from writing data to sector 524B of second data track 524. Upon refraining from writing data to sector 524B, controller 7 may cause write head 8 to move to the next sector of second data track 524 (e.g., sector 524C).

In some examples, EDM 18 may set an indicator indicating that data was not written to sector 524B. The indicator may specify a buffer address or range of buffer addresses (e.g., an address associated with primary write buffer 502 or secondary write buffer 508) corresponding to the data that was not written sector 524B. In some examples, the indicator may include an invalid flag indicating that sector 424B is invalid.

For each of the subsequent sectors of second data track 524 (e.g., sectors 524C-524G), controller 7 may determine whether writing data to the respective sector is likely to squeeze data in the corresponding sector of first data track 520 based on a PES value associated with the sector of second data track 524.

Upon completing writing data to the second data track, ECM 20 may perform a relocation operation. During the relocation operation, ECM 20 may reassign a section of the write buffer that was written to the second data track, such that the reassigned section may store a copy of the data that was not written to the second data track. ECM 20 may relocate the data that was not written to the second data track by causing data corresponding to the data that was not written to sector 524B to be copied from secondary write buffer region M1 to a reassigned section of primary write buffer 502. For example, ECM 20 may cause data to be copied from section M1_{B} to the section of primary write buffer 502 that corresponds to the last sector of the first subset of data (e.g., section 522G).

Controller 7 may prepare to write data to a third data track. For example, write module 28 may determine a second subset of data to write to a third data track 528, defined by sectors 528A-528G. In some examples, the second subset of data may include the relocated data at the reassigned section(s) of primary write buffer 502. For example, as illustrated in FIG. 5C, write module 28 may determine that the second subset of data includes sections 522G and 526A-526F from primary write buffer 502. Controller 7 may cause write head 8 to write the second subset of data to third data track 528. For example, as illustrated in FIG. 5C, write head 8 may write data corresponding to section 522G to sector 528A of third data track 528, data corresponding to section 526A to sector 528B, and so on.

During writing to third data track 528, EDM 18 may determine whether writing the second subset of data to a third data track 528 is likely to squeeze a data stored at second data track 524. Controller 7 may determine a PES value associated with a sector of third data track 528 (e.g., sector 528E) and a corresponding sector of adjacent, second data track 524 (e.g., sector 524E). EDM 18 may cause the PES value associated with sector 528 to be stored to PES buffer region P2. In some examples, EDM 18 may determine the PES value associated with sector 524E by retrieving the value from PES buffer region P1. EDM 18 may determine a PES distance associated with sector 528E and sector 524E and determine whether the PES distance is less than a threshold distance. In response to determining that the PES distance is less than the threshold PES distance, EDM 18 may set an indicator indicating that the data stored at sector 524E of the second track is likely squeezed. The indicator may specify a buffer address or range of buffer addresses (e.g., an address associated with primary write buffer 502 or secondary write buffer 508) corresponding to a copy of the data written to squeezed sector 524E. EDM 18 may set an indicator indicating that the potentially squeezed sectors are invalid. FIG. 5D shows an example where EDM 18 has determined that several sectors of second data track 524 (sectors 524E and 524F) were squeezed by writing third data track 528.

In some examples, after completing writing to third data track 528, ECM 20 may perform a relocation operation, copying data from secondary write buffer region M1 to the reassigned sectors. After relocating data corresponding to squeezed sectors 524E and 524F from secondary write buffer region M1 to write buffer sections 526E and 526F, controller 7 may cause the PES values stored at PES buffer region P2 to be copied to PES buffer region P1. Controller 7 may determine a third subset of data to write to fourth data track 532 (defined by sectors 532A-G). The third subset of data may include relocated data stored at write buffer sections 526E and 526F.

Controller 7 may continue writing data to shingled track region 504 from primary write buffer 502 and storing PES values for the respective sectors to PES buffer region P2. EDM 18 may determine whether writing data to the subsequent data tracks is likely to squeeze data previously written to an adjacent. If EDM 18 determines that data stored at a sector of a previous data track are squeezed, EDM 18 may set an indicator indicating the previously written data is likely squeezed. ECM 20 may perform a relocation operation to copy data corresponding to the squeezed data back to primary write buffer 502 so that the data may be re-written to a later data track. Controller 7 may continue this process until all of the data stored at primary write buffer 502 is written to shingled track region 504 without squeezing any of the previously written data.

In some examples, ECM 20 may cause write head 8 to perform a defragmentation operation. ECM 20 may determine an original write order for the data stored at shingled track region 504. ECM 20 may cause write head 8 to write the data to another shingled track region 410 in the original write order. During the defragmentation operation, EDM 18 may determine whether writing data to a track of shingled track region 510 is likely to squeeze a previously written adjacent data track, as described above.

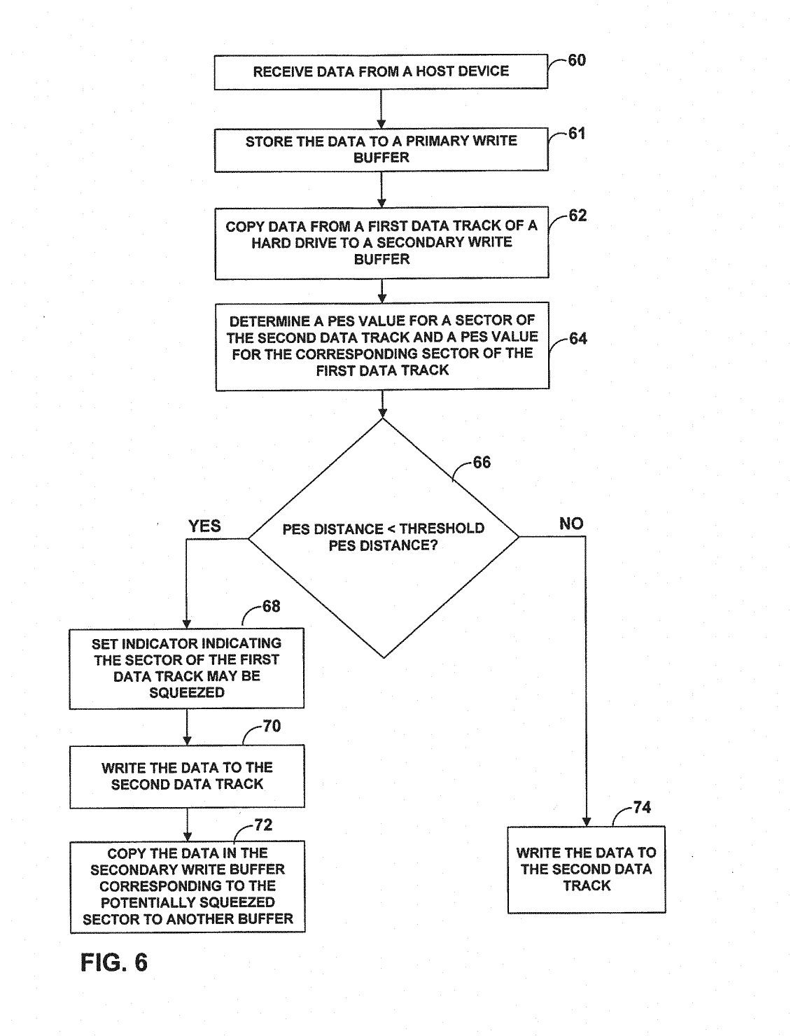

FIG. 6 is a flow diagram illustrating an example technique that at least one processor may implement for maintaining the integrity of data stored by a magnetic data storage device, in accordance with one or more techniques of this disclosure. Various components and modules (e.g., error management module 16) of storage device 6 may perform the techniques described in this disclosure. The technique of FIG. 6 will be described with respect to storage environment 2 of FIG. 1 and controller 7 of FIGS. 1 and 2 for purposes of illustration. However, it will be understood that the technique of FIG. 6 may be performed by a different processor or in a different storage environment, and that controller 7 and storage environment 2 may perform other techniques.

Controller 7 may receive a write command from host device 4 via interface 14 (60). The write command may include data and at least one LBA indicating the logical address with the data is associated. In some examples, controller 7 may cause the data to be stored in a cache 9, such as a primary write buffer (61).

In some examples, magnetic data storage device 12 may include previously written data at a first data track. Controller 7 may cause data at the first data track to be copied to a cache 9, such as a secondary write buffer (62).

Controller 7 may begin a first write operation. In some examples, write module 28 may determine a subset of data in the primary write buffer to write to a second data track of magnetic data storage device 12. Controller 7 may cause a copy of the subset of data to be copied from the primary write buffer to the secondary write buffer.

During the first write operation, EDM 18 may determine whether writing data to a sector of the second data track is likely to squeeze data stored at a corresponding sector of the first data track. EDM 18 may base the determination at least in part on a PES value associated with the sector of the second data track and a PES value associated with the corresponding sector of the first, adjacent data track. Controller 7 may determine a PES value associated with a sector of the second data track and a PES value associated with a corresponding sector of the first, adjacent data track (64). In some examples, servo control module 22 may track the physical position of the read/write head relative to magnetic data storage device 12 in order to determine the PES value associate with the sector of the second data track and the PES value of the corresponding adjacent sector of the first data track. However, in some examples, servo control module 22 may communicate a signal indicative of the physical position of the read/write head to EDM 18 for use in determining the PES values for the respective sectors.

In some instances, EDM 18 may determine a PES distance based on the PES value associated with the sector of the second data track and the PES value associated with the corresponding sector of the first data track, and may determine whether the PES distance is less than a threshold PES distance (66). A PES distance greater than or equal to the PES threshold distance may indicate that writing data to the second data track is unlikely (or less likely) to affect data in the first data track. In some examples, if EDM 18 determines the PES distances is greater than or equal to the threshold PES distance, EDM 18 may cause write head 8 to write data to the second data track (74). A PES distance less than the threshold PES distance may indicate that writing data to the second data track is likely to squeeze data in the first data track. In some examples, if the PES distance is less than a threshold PES distance, EDM 18 may set an indicator indicating data stored at the sector of the first data track is likely to be squeezed. (68). For example, the indicator may include a secondary write buffer address to identify the data from the secondary write buffer that corresponds to the data stored at the squeezed sector of the first data track. In some examples, EDM 18 may set the indicator indicating the data was not written by setting the squeezed sector to invalid (e.g., by updating an “invalid” flag). In some examples, ECM 20 may cause the data that corresponds to the squeezed sector of the first data track to be copied from the secondary write buffer to another buffer (72). For example, ECM 20 may cause the data to be copied from the secondary write buffer back to the write buffer. As another example, ECM 20 may cause the data to be copied from the secondary write buffer to a tertiary write buffer.

In some examples, after writing data to the second data track, storage device 6 may release the portion of the write buffer corresponding to the written data such that the portion of the write buffer may be used to store additional data as it is received from the host. However, in some examples, storage device 6 may store the data in the write buffer until write head 8 has finished writing all of the data associated with the write command.

Controller 7 may prepare to write data to a third data track after writing the first subset of data to the second data track. Write module 28 may determine a subset of data from the write buffer to a subsequent data track. Controller 7 may cause the subset of data to be copied to the secondary write buffer. EDM 18 may determine whether writing data to the subsequent data track is likely to squeeze data that was previously written to an existing data track. If EDM 18 determines that writing data to the subsequent data track is likely to squeeze data at a previously written data track, ECM 20 may copy data corresponding to the squeezed sector from the secondary write buffer to another location. In this way, EMM 16 may cause all of the data in the write buffer to be written to the storage device 6 without losing data that may be corrupted or squeezed by writing subsequent data.

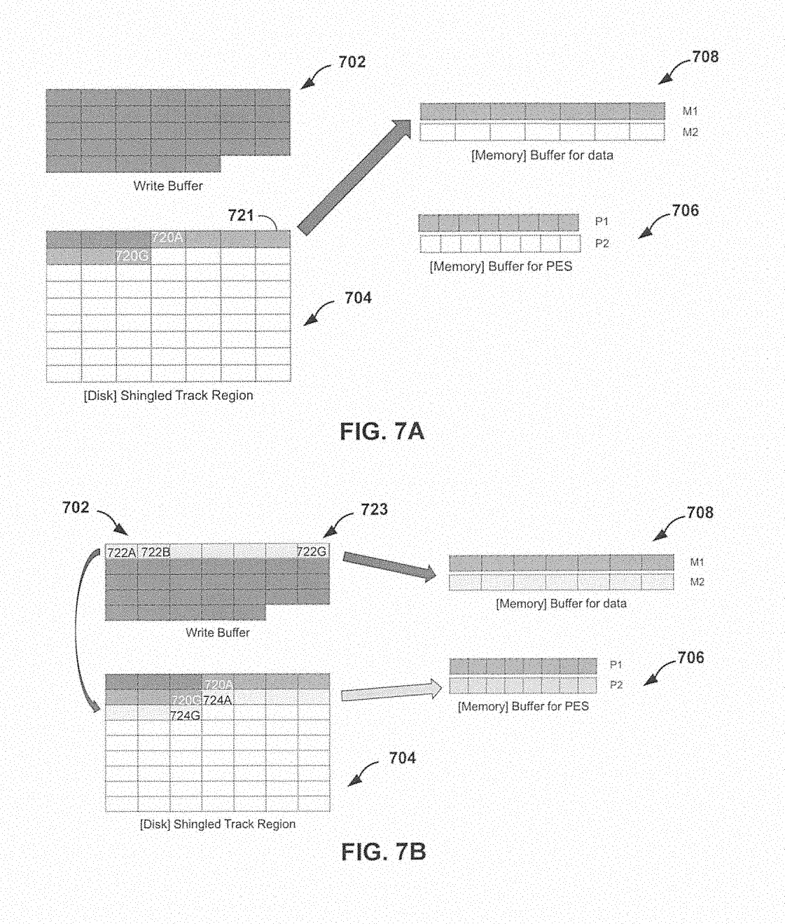

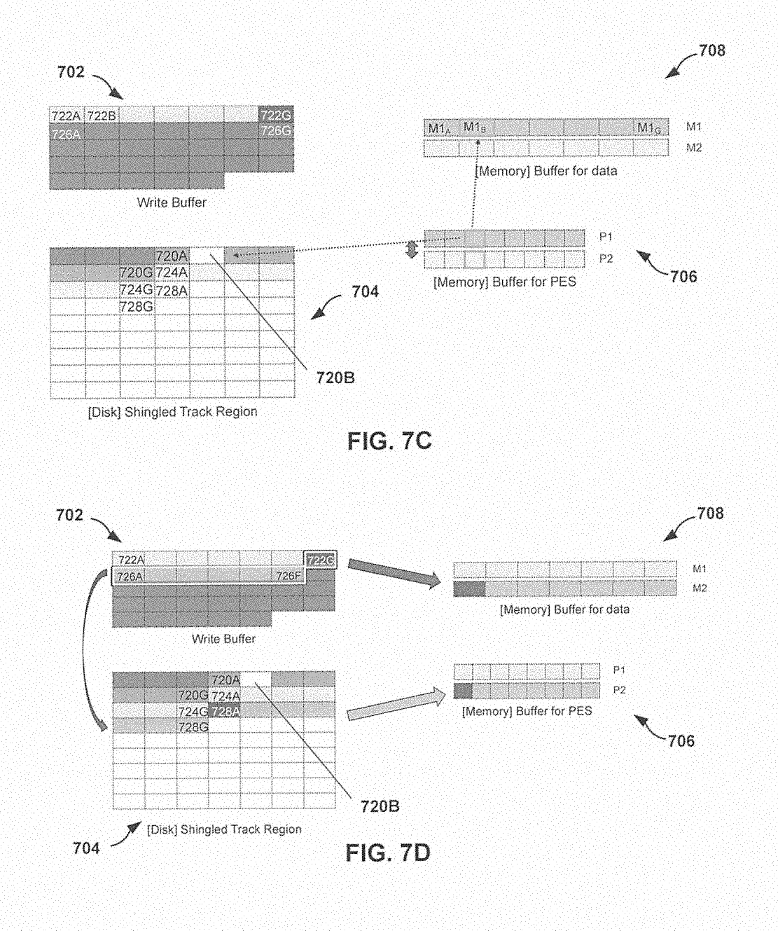

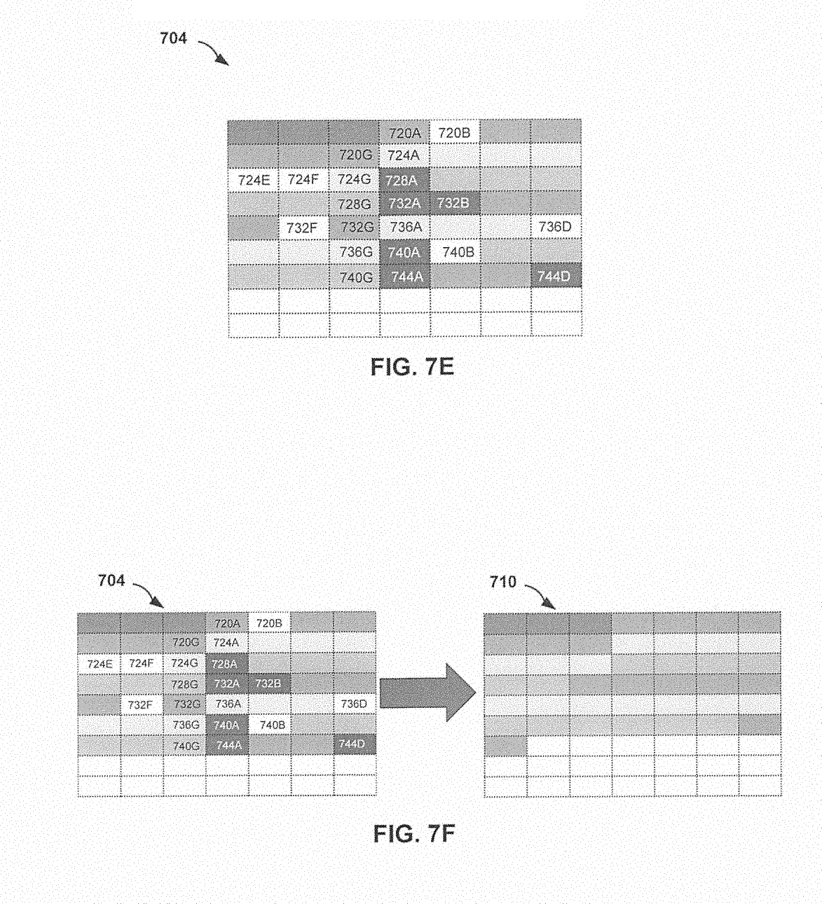

FIGS. 7A-7F are conceptual diagrams illustrating an example technique that at least one processor may implement for maintaining the integrity of data stored by a magnetic data storage device, in accordance with one or more techniques of this disclosure. For purposes of illustration, the technique will be described with reference to the flow diagram of FIG. 6 and with respect to storage environment 2 of FIG. 1 and controller 7 of FIGS. 1 and 2. However, it will be understood that the technique of FIGS. 7A-7F may include additional or fewer steps.

With reference to FIG. 7A, in some examples, storage device 6 may include one or more magnetic data storage devices 12. Magnetic data storage device 12 may include a non-shingled track region and a shingled track region 704. Shingled track region 704 includes a plurality of data tracks, and each track includes a plurality of sectors. Shingled track region 704 may include pre-existing data at a first data track. For purposes of illustration only, in FIG. 7A, the first data track 720 is defined by sectors 720A-720G, as shown by shaded region 721. For ease of illustration only, shingled track region 704 is shown with seven sectors per data track. However, it is to be understood that each track of shingled track region 704 may include any number of sectors.

Storage device 6 may include one or more cache devices 9, such as primary write buffer 702, PES buffer 706, and secondary write buffer 708. In some examples, primary write buffer 702, PES buffer 706, and secondary write buffer 708 may be part of the same physical cache 9, or may be independent cache devices. Primary write buffer 702 may temporarily store data received from host device 4. PES buffer 706 may store PES values associated with data tracks of shingled track region 704. In some examples, PES buffer 706 may include two or more buffer regions, such as PES buffer region P1 and PES buffer region P2, which may store PES values for a first data track of shingled track region 704 and a second data track of shingled track region 704, respectively. PES buffer region P1 may store PES values associated with one or more sectors of the data that was previously written to first data track 720. Secondary write buffer 708 may temporarily store a copy of data previously written to shingled track region 704 and/or a copy of at least a portion of the data stored at primary write buffer 704. In some examples, secondary write buffer 708 may include two or more buffer regions, such as secondary write buffer regions M1 and M2. For example, secondary write buffer region M1 may store a copy of data written to a first data track of shingled track region 704 and secondary write buffer region M2 may store a copy of the data to be written to a second data track of shingled track region 704.

With further reference to FIG. 7A, storage device 6 may receive a write command and data from host device 4. In some examples, controller 7 may receive the write command and cause the data to be stored in primary write buffer 702. Controller 7 may read the data stored at the first data track 720 of shingled track region 704 and store a copy of the data to write buffer region M1 (708) as shown in FIG. 7A.

In response to receiving the write command and data from host device 4, controller 7 may initiate a first write operation associated with the received write command, as illustrated in FIG. 7B. During the first write operation, write module 28 may determine a first subset of data, defined by sections 722A-722G, as shown by shaded region 723, to write to a second data track of shingled track region 704. For purposes of illustration only, second data track 724 is defined by sectors 724A-724G.

During the first write operation, controller 7 may determine a PES value associated with a first sector of second data track 724 (e.g., sector 724A) and a corresponding sector of adjacent, first data track 720 (e.g., sector 720A). Servo control module 22 may track the physical position of the read/write head and determine the PES value associated with sector 724A, or servo control module 22 may communicate a signal indicative of the physical position of the read/write head to EDM 18 for use in determining the PES value associated with sector 724A. EDM 18 may cause the PES value associated with sector 724A to be stored to PES buffer region P2. In some examples, EDM 18 may determine the PES value associated with sector 720A by retrieving the value from PES buffer region P1.

In some examples, controller 7 may cause write head 8 to write the first subset of data to second data track 724 and then determine whether writing the data likely squeezed data at any of the sectors of first data track 720. However, in some examples, controller 7 may determine whether writing data to a sector (e.g., sector 724A) of second data track 724 is likely to squeeze data stored at a corresponding sector of first data track 720 prior to (or during) writing the sector of second data track 724.

EDM 18 may determine whether writing data to sector 724A of second data track 724 is likely to squeeze data stored at a corresponding sector 720A of the first data track 720 based on the PES values associated with the respective sectors. For example, EDM 18 may determine a PES distance based on the PES values and determine whether the PES distance is less than a threshold PES distance. A PES distance greater than a threshold PES distance may indicate that writing data to sector 724A is not likely to squeeze data stored at sector 720A. If EDM 18 determines that the PES distance associated with sectors 724A and 720A is greater than the threshold PES distance, controller 7 may cause write head 8 to write data to sector 724A of second track 724 and to move to the next sector of second data track 724 (e.g., sector 724B).

In response to the write head moving to sector 724B, controller 7 may determine the PES value associated with sector 724B and may store the PES value in PES buffer region P2. EDM 18 may retrieve the PES value associated with sector 720B of the first data track from PES buffer region P1. EDM 18 may determine whether writing data to sector 724B of second data track 724 is likely to squeeze sector 720B of adjacent, first data track 720 by determining a PES distance associated with the PES values associated with sectors 724B and 720B, respectively. A PES distance less than the threshold PES distance may indicate that writing data to sector 724B is likely to affect, or “squeeze”, data stored at sector 720B (e.g, due to external vibrations of storage device 6). As illustrated in FIG. 7C, in some examples, EDM 18 may determine that the PES distance associated with sectors 724B and 720B is less than the threshold PES distance. As a result, EDM 18 may set an indicator indicating the data stored at sector 720B is likely to be squeezed. Because a copy of the data written to sector 720B still exists in secondary write buffer 708, in some examples, the indicator may specify a secondary write buffer address, or a range of secondary write buffer addresses, corresponding to the data at sector 720B. In some examples, EDM 18 may set the indicator by setting an invalid flag associated with sector 720B to invalid. Write module 28 may cause write head 8 to write data to sector 724B and move to sector 724C. Controller 7 may continue writing data to the remaining sectors of second data track 724 in a similar manner as described above.

As shown in FIG. 7C, in some examples, ECM 20 may perform a data relocation operation after write head 8 has finished writing data to second data track 724. ECM 20 may reassign a section of primary write buffer 702 so that reassigned may be used to store data corresponding to a squeezed sector of a previously written data track. For example, data stored at section M1_{B} of secondary write buffer region M1 may correspond to section 720B of the first data track and ECM 20 may cause controller 7 to relocate, or copy, data from secondary write buffer region M1 to section 722G of primary write buffer 702.

With reference to FIG. 7D, after performing the data relocation operation, controller 7 may initiate a second write operation to write data to a third data track or resume the first write operation to write data to the third data track. Controller 7 may cause the PES values stored at PES buffer region P2 to be copied to PES buffer region P1. Likewise, controller 7 may cause the data stored at secondary write buffer region M2 to be copied to secondary write buffer region M1. In this way, PES buffer region P2 and secondary write buffer region M2 may be used to store information associated with a second subset of data while retaining the information associated with the first subset of data.

Write module 28 may determine a second subset of data to write to a third data track 728, defined by sectors 728A-728G. In some examples, the second subset of data may include the relocated data at the reassigned section(s) of primary write buffer 702. For example, as illustrated in FIG. 7D, write module 28 may determine that the second subset of data includes sections 722G and 726A-726F from primary write buffer 702. Controller 7 may cause write head 8 to write the second subset of data to third data track 728. For example, as illustrated in FIG. 7C, write head 8 may write data corresponding to section 722G to sector 728A of third data track 728, data corresponding to section 726A to sector 728B, and so on. Controller 7 may cause the second subset of data to be copied to secondary write buffer region M2.

During writing to the third data track, controller 7 may determine PES values for the sectors of third data track 728 and cause the PES values to be stored at PES buffer region P2. EDM 18 may determine whether writing the second subset of data to a third data track 728 is likely to squeeze data stored at second data track 724 by determining whether a PES distance associated with a sector of the third data track and a corresponding sector of the second, adjacent data track is less than a threshold distance. If the PES distance is less than the threshold PES distance, EDM 18 may set an indicator indicating that the data stored at the sector of second data track 724 is likely squeezed. The indicator may specify a buffer address or range of buffer addresses (e.g., an address associated with primary write buffer 702 or secondary write buffer 708) corresponding to a copy of the data written to the squeezed sector and/or may include an invalid flag indicating the sector is invalid.

In some examples, after writing data to the third data track, ECM 20 may perform a relocation operation, as described above.

After performing a relocation operation, controller 7 may continue writing data to shingled track region 704 from primary write buffer 702 and storing PES values for the respective sectors to PES buffer region P2. EDM 18 may determine whether writing data to the subsequent data tracks is likely to squeeze data previously written to an adjacent. If EDM 18 determines that data stored at a sector of a previous data track, EDM 18 may set an indicator indicating the previously written data is likely squeezed. ECM 20 may perform a relocation operation to copy data corresponding to the squeezed data back to primary write buffer 702 so that the data may be re-written to a later data track. Controller 7 may continue this process until all of the data stored at primary write buffer 702 is written to shingled track region 704 without squeezing any of the previously written data.

FIG. 7E illustrates an example shingled track region 704 after writing data to a plurality of data tracks. For example, during a previous write operation, write head 8 may have written data to sectors 720A-720G of first data track 720. As shown in FIG. 7E, the white sectors (e.g., 720B, 724E, 724F, 732F, 736D, and 740B) represent sectors that EDM 18 determined were likely squeezed by a subsequent write operation while the black sectors (e.g., 728A, 732A, 732B, 740A, 744A, and 744D) represent copies of the potentially squeezed sectors that were relocated by ECM 20.

As illustrated in FIG. 7F, in some examples, ECM 20 may cause write head 8 to perform a defragmentation operation. ECM 20 may determine an original write order for the data stored at shingled track region 704. ECM 20 may cause write head 8 to write the data to another shingled track region 710 in the original write order. During the defragmentation operation, EDM 18 may determine whether writing data to a track of shingled track region 710 is likely to squeeze a previously written adjacent data track, as described above and ECM 20 may perform data relocation operations as described above.

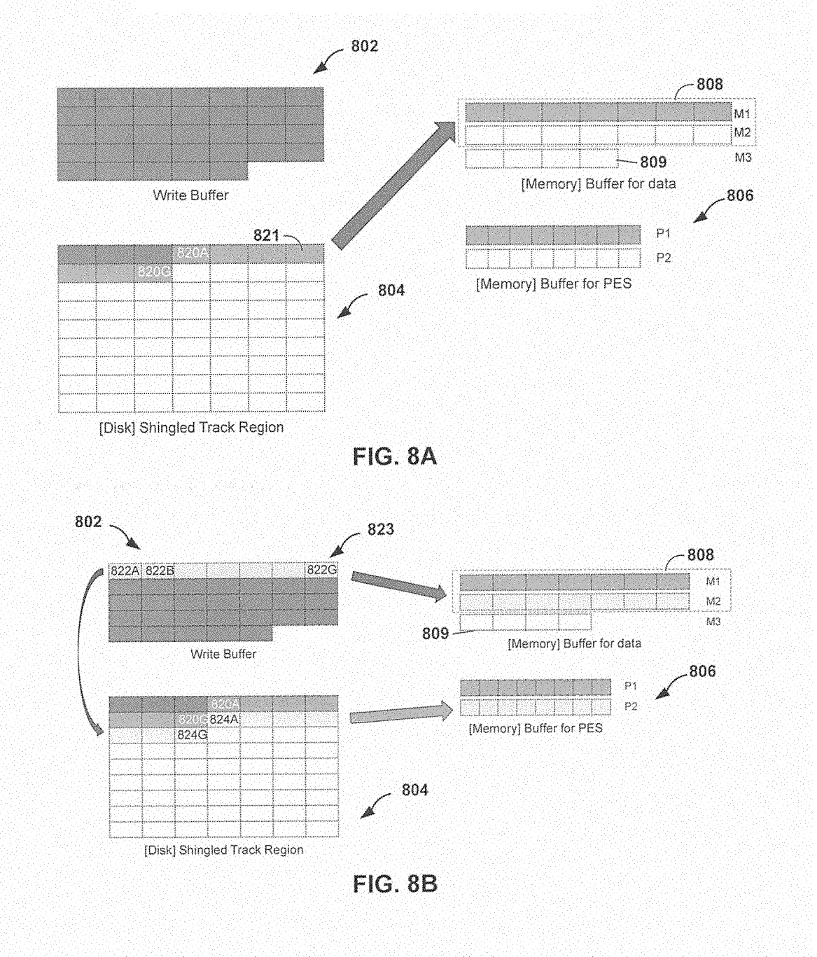

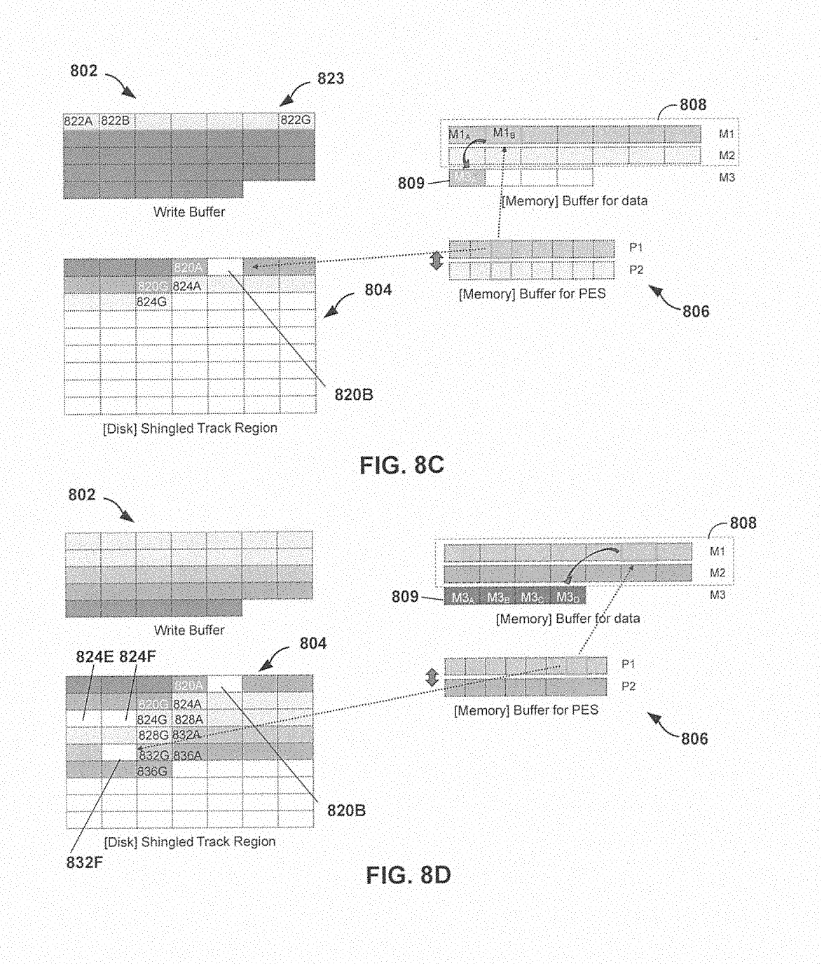

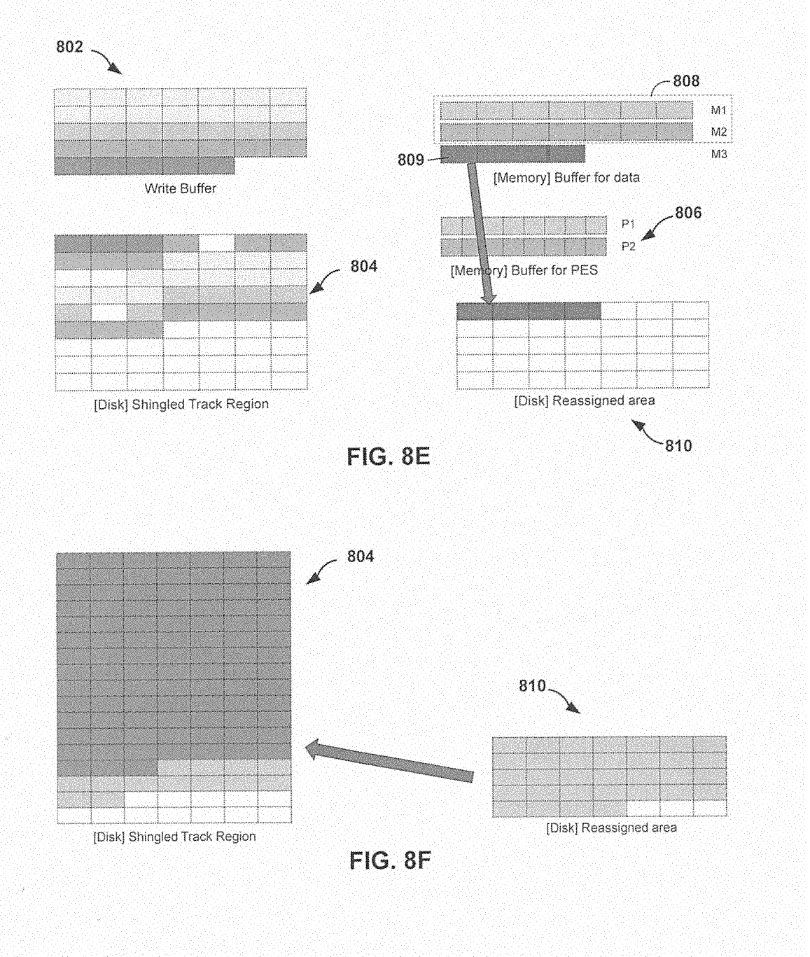

FIGS. 8A-8F are conceptual diagrams illustrating an example technique that at least one processor may implement for maintaining the integrity of data stored by a magnetic data storage device, in accordance with one or more techniques of this disclosure. For purposes of illustration, the technique will be described with reference to the flow diagram of FIG. 6 and with respect to storage environment 2 of FIG. 1 and controller 7 of FIGS. 1 and 2. However, it will be understood that the technique of FIGS. 8A-8E may include additional or fewer steps.

As shown in FIG. 8A, storage device 6 may include one or more magnetic data storage device 12, which may include a non-shingled track region and shingled track region 804. Shingled track region 804 may correspond to shingled track region 704, as described in FIGS. 7A-7F. Storage device 6 may include one or more caches 9, such as primary write buffer 802, PES buffer 806, secondary write buffer 808, and tertiary write buffer 809. Primary write buffer 802, PES buffer 806, and secondary write buffer 808 may correspond to primary write buffer 702, PES buffer 706, and secondary write buffer 708, as described in FIGS. 7A-7F. In some example tertiary write buffer 809 may store relocated copies of data.

With further reference to FIG. 8A, storage device 6 may receive a write command and data from host device 4. In some examples, controller 7 may receive the write command and cause the data to be stored in primary write buffer 802. Controller 7 may read the data stored at the first data track 820 of shingled track region 804 and store a copy of the data to write buffer region M1 (808) as shown in FIG. 8A.

In response to receiving the write command and data from host device 4, controller 7 may initiate a first write operation associated with the received write command, as illustrated in FIG. 8B. During the first write operation, write module 28 may determine a first subset of data, defined by sections 822A-822G, as shown by shaded region 823, to write to a second data track of shingled track region 804. For purposes of illustration only, second data track 824 is defined by sectors 824A-824G.

In some examples, controller 7 may cause a copy of the first subset of data to be stored at region M2 of secondary write buffer 808 in a similar manner as described with reference to FIGS. 7A-7F. Likewise, controller 7 may cause PES values associated with the second data track to be stored in PES buffer region P2 in a similar manner as described with reference to FIGS. 7A-7F.

As shown in FIG. 8C, in some examples, EDM 18 may determine whether writing data to the second data track will likely squeeze data written to the first data track by comparing a PES distance to a threshold PES distance, in a similar manner as described with reference to FIGS. 7A-7F. For example, EDM 18 may determine that writing data to sector 824B of second track 824 is likely to squeeze sector 820B of first data track 820 and may set an indicator indicating that writing data to sector 824B is likely to squeeze data stored at sector 820B. The indicator may identify data corresponding to the data stored at sector 820B and/or designate the sector 820B as invalid.

As shown in FIG. 8C, in some examples, ECM 20 may perform a data relocation operation after write head 8 has finished writing data to second data track 824. For example, ECM 20 may relocate data associated with the data stored at sector 820B by copying data from secondary write buffer M1 (e.g., section M1_{B}) to tertiary write buffer 809 (e.g., section M3_{A}). In some examples, controller 7 may cause data stored at tertiary write buffer 809 to be copied to non-volatile memory, such as a non-shingled portion of magnetic data storage device 12 or a flash memory device.

In some examples, after relocating data from secondary write buffer region M1 to tertiary write buffer 809, controller 7 may cause the PES values stored at PES buffer region P2 to be copied to PES buffer region P1. Likewise, controller 7 may cause the data stored at secondary write buffer region M2 to be copied to secondary write buffer region M1. In this way, PES buffer region P2 and secondary write buffer region M2 may be used to store information associated with a second subset of data while retaining the information associated with the first subset of data.

Controller 7 may prepare to write data to additional data tracks. For example, write module 28 may determine a subset of data to write to a subsequent data track. Controller 7 may cause a copy of the subset of data to be written to secondary write buffer region M2 and may cause PES values associated with the subsequent data track to be stored at PES buffer region P2. During writing to the additional data tracks, EDM 18 may determine whether writing data to the subsequent data track is likely to squeeze data stored at a previously written adjacent data track. If EDM 18 determines that writing to the subsequent data track is likely to squeeze data stored at the previously written adjacent data track, ECM 20 may cause a copy of data associated with the squeezed sector to be copied from secondary write buffer region M1 to tertiary write buffer 809. As a result, controller 7 may retain a valid copy of the previously written data and the data received from host device 4.

FIG. 8D illustrates the results of writing data to a plurality of data tracks. The white sectors (e.g., 820B, 824E, 824F, and 832F) represent sectors that EDM 18 determined were likely squeezed by writing data to a subsequent data tracks. ECM 20 relocated data corresponding to each of the squeezed sectors from secondary write buffer region M1 to tertiary write buffer 809.

In some examples, ECM 20 may relocate the data stored in tertiary write buffer 809 to another storage location. ECM 20 may determine an occupied portion of tertiary write buffer 809 and cause the data at tertiary write buffer 809 to be copied to another location if the occupied portion of tertiary write buffer 809 is greater than a threshold portion. For example, ECM 20 may relocate data from tertiary write buffer 809 when tertiary write buffer 809 is full (e.g., each section of tertiary write buffer 809 includes data). As another example, ECM 20 may relocate data from tertiary write buffer 809 when at least a threshold number of tertiary write buffer sections include data.

As illustrated in FIG. 8E, in some examples, ECM 20 may cause data to be copied from tertiary write buffer 809 to a portion of magnetic data storage device 12. For example, ECM 20 may cause data in tertiary write buffer 809 to be copied to shingled track region 804. In some examples, ECM 20 may cause data in tertiary write buffer 809 to be copied to a reassignment area 810 within magnetic data storage device 12. Reassignment area 810 may include a shingled track region or a non-shingled track region.

In some examples, ECM 20 may determine an occupied portion of reassignment area 810 and cause the data at from reassignment area 810 to be copied from reassignment area 810 to shingled track region 804 if the occupied portion of reassignment area 810 is greater than a threshold portion. For example, as illustrated in FIG. 8F, ECM 20 may cause data to be copied from reassignment area 810 to shingled track region 804.

In some examples, write head 8 to perform a defragmentation operation. ECM 20 may determine an original write order for the data stored at shingled track region 804. ECM 20 may cause write head 8 to write the data to another shingled track region in the original write order. During the defragmentation operation, EDM 18 may determine whether writing data to a track of shingled track region 810 is likely to squeeze a previously written adjacent data track, as described above and ECM 20 may perform data relocation operations as described above.

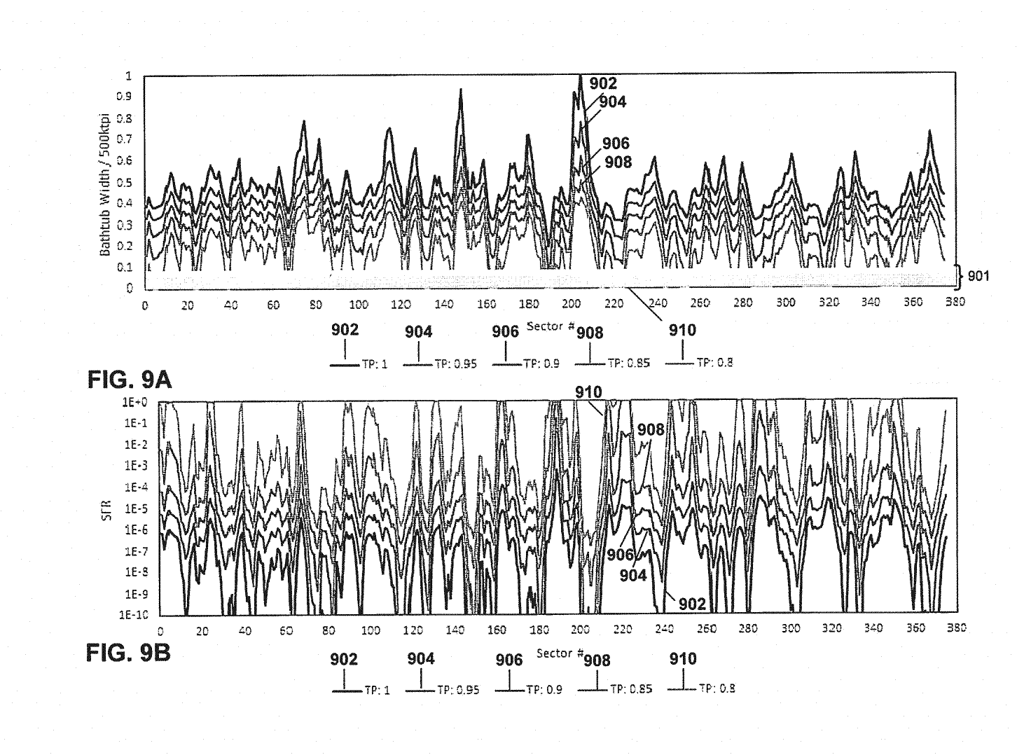

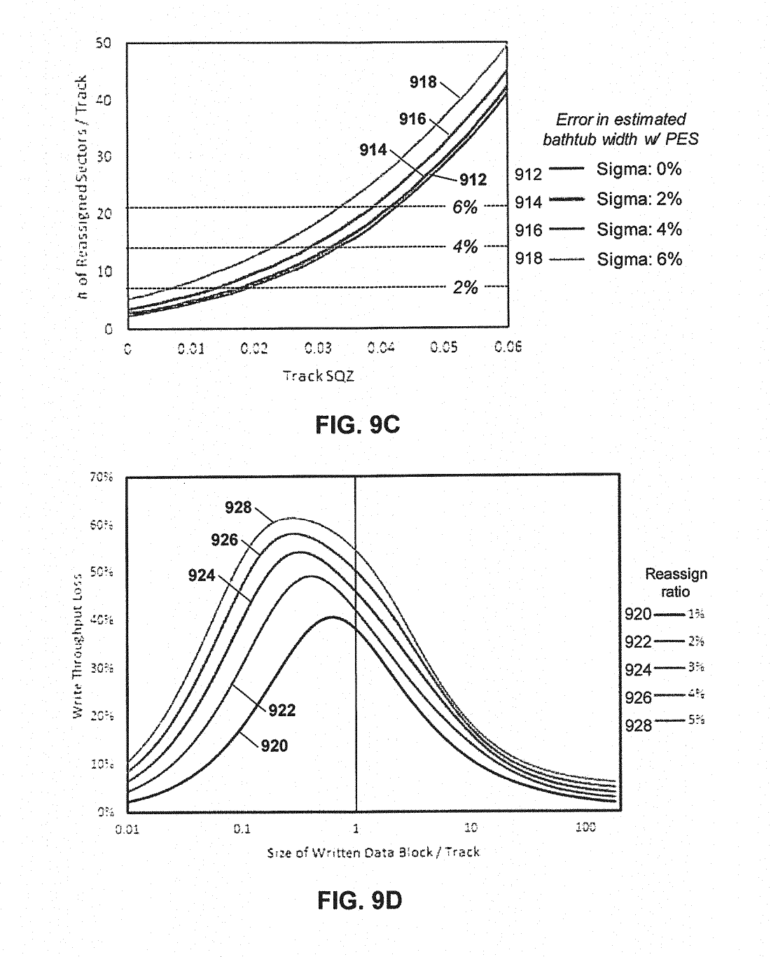

FIGS. 9A-9D are graphs illustrating example measurement results of a technique for maintaining the integrity of data stored by a magnetic data storage device, in accordance with one or more techniques of this disclosure.

FIG. 9A illustrates an example write operation, using techniques described in this disclosure, to write data at sectors 1-380 of an example data track. The Y-axis shows the bathtub width for each sector for a variety of track pitch levels when it is written under external vibration. Curve 902 shows the actual experimental bathtub width for a nominal track pitch. Curve 904 shows the estimated bathtub width for each sector if the track pitch were to be set to 95% of the nominal track pitch when the same external vibration is applied as above. Likewise, curves 906, 908, and 910 show the estimated bathtub width for each sector if the track pitch were set to 90%, 85%, and 80% of the nominal track pitch. As shown in FIG. 9A, decreasing the track width decreases the bathtub width. As shown by shaded section 901, controller 7 may relocate data when the bathtub width associated with the respective sector falls below a threshold width.

FIG. 9B shows the sector failure rate (SFR) for the same example write operation shown in FIG. 9A. The SFR may be strongly correlated to the bathtub width. Thus, as the track pitch is decreased, the bathtub width also decreases and the SFR increases. For example, looking at the curve 902 with a nominal track pitch of 1, at approximately sector 210, the bathtub width is nearly 0.5 and the SFR is approximately 1E-10. However, looking at curve 910, for the same sector (approximately 210), the estimated bathtub width is approximately 0.2 and the estimated SFR is approximately 1E-3.

FIG. 9C illustrates the estimated number of relocated sectors per track as the TPI is increased while writing under external vibration. The Y-axis shows the number of relocated sectors per track for a sample hard drive having 356 sectors per track. The X-axis shows the increase in TPI over conventional settings. Each curve indicates the estimated error in the bathtub width using PES information to determine the bathtub width. For example, curve 912 indicates no error in the estimated bathtub width, curve 914 indicates a 2% error (in standard deviation) in the estimated bathtub width, and so on. Looking at curve 914, increasing the TPI by 2% over conventional TPI causes about 8 sectors per track to be re-assigned. As a result, increasing TPI by 2% causes about 2% increase in writes (8/356). However, in some examples, increasing TPI may cause the number of sectors to increase more than the increased storage created by increasing TPI. As a result, there may be a net loss of storage while writing under external vibration. However, since the drive may not experience external vibrations all of the time, the techniques described in this disclosure may allow an increase in TPI for all write commands while increasing the number of relocated sectors only when the drive experiences external vibrations.

FIG. 9D illustrates experimental results showing write throughput loss using techniques described in this disclosure to write data while experiencing external vibrations. The graph illustrates the write throughput loss (y-axis) as a function of the written data block (x-axis). The X-axis is normalized by the size of the data track, such that a “1” on the x-axis indicates the written data block is a full data track, “0.1” indicates that the written data block is 10% of a data track, and a “10” indicates that the written data block is 10 data tracks. Curves 920, 622, 924, 926, and 928 illustrate how the write throughput loss changes as a function of the size of the written data block for the various re-assignment ratios. For example, at a 5% re-assignment ratio (928), if the amount of data written to magnetic data storage device 12 includes one full data track, the write throughput loss was approximately 55%. However, at a 1% re-assignment ratio (920), if the amount of data written to magnetic data storage device 12 includes one full data track, the write throughput loss was approximately 40%. In conventional techniques, the write throughput loss may be much higher (as high as 100%) when writing data under external vibrations. Thus, as shown in FIG. 9B, the described techniques may reduce write throughput loss while retaining the integrity of the data written to magnetic data storage device 12.

The techniques described in this disclosure may be implemented, at least in part, in hardware, software, firmware, or any combination thereof. For example, various aspects of the described techniques may be implemented within one or more processing units, including one or more microprocessing units, digital signal processing units (DSPs), application specific integrated circuits (ASICs), field programmable gate arrays (FPGAs), or any other equivalent integrated or discrete logic circuitry, as well as any combinations of such components. The term “processing unit” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage device encoded with instructions. Instructions embedded or encoded in an article of manufacture including a computer-readable storage device, may cause one or more programmable processing units, or other processing units, to implement one or more of the techniques described herein, such as when instructions included or encoded in the computer-readable storage device are executed by the one or more processing units. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage device may include a non-transitory medium. The term “non-transitory” may indicate that the storage device is not embodied in a carrier wave or a propagated signal. In certain examples, a non-transitory storage device may store data that can, over time, change (e.g., in RAM or cache).

Various examples of the disclosure have been described. Any combination of the described systems, operations, or functions is contemplated. These and other examples are within the scope of the following claims.

1. A method comprising:
during writing of data to a second data track of a hard drive, determining, by at least one processor and based on a position error signal (PES) for a sector of the second data track, whether the distance between the sector of the second data track and a corresponding sector of a first data track is less than a threshold distance, wherein the second data track is adjacent to the first data track and the first data track stores previously written data;
in response to determining that the distance between the sector of the first data track and the corresponding sector of the second data track is less than the threshold distance:
causing, by the at least one processor, a write head to refrain from writing data to the corresponding sector of the second data track;
setting, by the at least one processor, an indicator associated with the second data track indicating that the data was not written to the corresponding sector of the second data track;
during writing of data to a fourth data track of the hard drive, determining, by the at least one processor and based on a PES for a sector of a third data track of the hard drive and a PES for a corresponding sector of the fourth data track, whether the distance between the sector of the third data track and the corresponding sector of the fourth data track is less than the threshold distance, wherein the fourth data track is adjacent to the third track and the third data track stores previously written data;
in response to determining that the distance between the sector of the third data track and the corresponding sector of the fourth data track is less than the threshold distance:
setting, by the at least one processor, an indicator associated with the third data track indicating that the sector of the third data track may be squeezed; and
causing, by the at least one processor, a write head to write data to the corresponding sector of the fourth data track.

2. The method of claim 1, further comprising:
in response to writing data to the fourth data track:
causing, by the at least one processor, a write head to write to a fifth data track data corresponding to the data that was not written to the sector of the second data track and data corresponding to the data written to the sector of the third data track that may be squeezed.

3. The method of claim 2, wherein the fifth data track is adjacent to the fourth data track, the method further comprising:
during writing of data to the fifth data track, determining, by the at least one processor and based on a PES for a sector of the fourth data track and a PES for a corresponding sector of the fifth data track, whether the distance between the sector of the fourth data track and the corresponding sector of the fifth data track is less than the threshold distance; and
in response to determining that the distance between the sector of the fourth data track and the corresponding sector of the fifth data track is less than the threshold distance:
causing, by the at least one processor, a write head to write to a secondary storage area data corresponding to the data written to the sector of the fourth data track.

4. The method of claim 3, wherein a first shingled magnetic recording (SMR) portion of the hard drive comprises the first, second, third, fourth, and fifth data tracks, and wherein a non-shingled portion of the hard drive comprises the secondary storage area, the method further comprising:
causing, by the at least one processor, defragmenting of the first SMR portion of the hard drive by at least:
determining, by the at least one processor, an original order of the data in the secondary storage area and the data in the first SMR portion of the hard drive; and
causing, by the at least one processor, a write head to write at least a portion of the data in the secondary storage area and at least a portion of the data from the first SMR portion of the hard drive to a second SMR portion of the hard drive in the original order of the data.

5. The method of claim 1, further comprising:
causing, by the at least one processor, the PES for at least one sector of the first data track to be stored in a first PES buffer;
causing, by the at least one processor, the PES for at least one sector of the second data track to be stored in a second PES buffer;
after writing data to the second data track, causing, by the at least one processor, data from the second PES buffer to be copied to the first PES buffer; and
in response to writing data to the third data track, causing, by the at least one processor, a PES for at least one sector of the third data track to be written to the second PES buffer.

6. The method of claim 1, further comprising:
causing, by the at least one processor, data corresponding to data to be written to the second data track to be copied from a primary write buffer and to a secondary write buffer;
wherein, in response to determining that the distance between the sector of the first data track and the corresponding sector of the second data track is less than the threshold distance further comprises:
causing, by the at least one processor, data corresponding to the sector of the second data track that was not written to be copied from the secondary write buffer and to the primary write buffer; and
causing, by the at least one processor, a write head to write, from the primary write buffer and to the third data track, data corresponding to the sector of the second data track that was not written.

7. The method of claim 6, further comprising:
causing, by the at least one processor, data corresponding to data to be written to the fourth data track to be copied from the primary write buffer and to the secondary write buffer;
wherein, in response to determining that the distance between the sector of the third data track and the corresponding sector of the fourth data track is less than the threshold distance further comprises:
causing, by the at least one processor, data corresponding to the sector of the third data track that may be squeezed to be copied from the secondary write buffer and to the primary write buffer; and
causing, by the at least one processor, a write head to write, from the primary write buffer and to a fifth data track, data corresponding to the sector of the third data track that may be squeezed.

8. The method of claim 1, further comprising:
causing, by the at least one processor, data corresponding to data to be written to the second data track to be copied from a primary write buffer and to a first secondary write buffer;
causing, by the at least one processor, data corresponding to data to be written to the third data track to be copied from the primary write buffer and to a second secondary write buffer; and
in response to writing to the third data track:
causing, by the at least one processor, data from the second secondary write buffer to be copied to the first secondary write buffer; and
causing, by the at least one processor, data corresponding to data to be written at the fourth data track to be copied from the primary write buffer and to the second secondary write buffer.

9. A method comprising:
causing, by at least one processor, data from a first data track of the hard drive to be copied to a secondary write buffer;
during writing of data to a second data track of the hard drive, determining, by the at least one processor and based on a position error signal (PES) for a sector of the first data track and a PES for a corresponding sector of the second data track, whether the distance between the sector of the first data track and the corresponding sector of the second data track is less than a threshold distance, wherein the second data track is adjacent to the first data track and the first data track stores previously written data;
in response to determining that the distance between the sector of the first data track and the corresponding sector of the second data track is less than the threshold distance:
setting, by the at least one processor, an indicator associated with the first data track indicating that the sector of the first data track may be squeezed;
causing, by the at least one processor, a write head to write to the second data track data to the corresponding sector of the second data track; and
causing, by the at least one processor, data corresponding to the sector of the first data track that may be squeezed to be copied from the secondary write buffer and to another buffer.

10. The method of claim 9, wherein the secondary write buffer comprises a first secondary write buffer, the method further comprising:
causing, by the at least one processor, data corresponding to the data to be written to the second data track to be copied to a second secondary write buffer;
in response to writing data to the second data track:
causing, by the at least one processor, data from the second secondary write buffer to be copied to the first secondary write buffer; and
causing, by the at least one processor, data to be written to a third data track of the hard drive to be copied to the second secondary write buffer.

11. The method of claim 9, further comprising:
causing, by the at least one processor, the PES for at least one sector of the first data track to be stored in a first PES buffer;
causing, by the at least one processor, the PES for at least one sector of the second data track to be stored in a second PES buffer;
after writing the data to the second data track, causing by the at least one processor, data from the second PES buffer to be copied to the first PES buffer; and
in response to writing data to a third data track of the hard drive, causing, by the at least one processor, a PES for at least one sector of the third data track to be written to the second PES buffer.

12. The method of claim 9, wherein copying data from the secondary write buffer to another buffer comprises copying data from the secondary write buffer to the primary write buffer, the method further comprising:
causing, by the at least one processor, a write head to write to a third data track of the hard drive the data copied from the secondary write buffer to the primary write buffer.

13. The method of claim 9, wherein copying data from the secondary write buffer to another buffer comprises copying data from the secondary write buffer to a tertiary write buffer, the method further comprising:
in response to determining that at least a threshold portion of the tertiary write buffer is full, causing, by the at least one processor, data from the tertiary write buffer to be copied to a third data track of the hard drive.

14. A storage device comprising:
a magnetic data storage device comprising:
a write head; and
a plurality of data tracks, wherein each of the plurality of data tracks comprises a respective plurality of data sectors; and
at least one processor configured to:
during writing of data to a second data track of a hard drive, determine, based on a position error signal (PES) for a sector of the second data track, whether the distance between the sector of the second data track and a corresponding sector of the first data track is less than a threshold distance, wherein the second data track is adjacent to the first data track and the first data track stores previously written data;
in response to determining that the distance between the sector of the first data track and the corresponding sector of the second data track is less than the threshold distance:
cause the write head to refrain from writing data to the corresponding sector of the second data track;
set an indicator associated with the second data track indicating that the data was not written to the corresponding sector of the second data track;
during writing of data to a fourth data track of the hard drive, determine, based on a PES for a sector of a third data track of the hard drive and a PES for a corresponding sector of the fourth data track, whether the distance between the sector of the third data track and the corresponding sector of the fourth data track is less than the threshold distance, wherein the fourth data track is adjacent to the third track and the third data track stores previously written data;
in response to determining that the distance between the sector of the third data track and the corresponding sector of the fourth data track is less than the threshold distance:
set an indicator associated with the third data track indicating that the sector of the third data track may be squeezed; and
cause the write head to write data to the corresponding sector of the fourth data track.

15. The storage device of claim 14, wherein the at least one processor is further configured to:
in response to writing data to the fourth data track:
cause the write head to write to a fifth data track data corresponding to the data that was not written to the sector of the second data track and data corresponding to the data written to the sector of the third data track that may be squeezed.

16. The storage device of claim 15, wherein the fifth data track is adjacent to the fourth data track, wherein the at least one processor is further configured to:
during writing of data to the fifth data track, determine, based on a PES for a sector of the fourth data track and a PES for a corresponding sector of the fifth data track, whether the distance between the sector of the fourth data track and the corresponding sector of the fifth data track is less than the threshold distance; and
in response to determining that the distance between the sector of the fourth data track and the corresponding sector of the fifth data track is less than the threshold distance:
cause the write head to write to a secondary storage area data corresponding to the data written to the sector of the fourth data track.

17. The device of claim 14, wherein the at least one processor is further configured to:
cause data corresponding to data to be written to the second data track to be copied from a primary write buffer and to a secondary write buffer;
in further response to determining that the distance between the sector of the first data track and the corresponding sector of the second data track is less than the threshold distance:
cause, data corresponding to the sector of the second data track that was not written to be copied from the secondary write buffer and to the primary write buffer; and
cause the write head to write, from the primary write buffer and to the third data track, data corresponding to the sector of the second data track that was not written.

18. A storage device comprising:
a magnetic data storage device comprising:
a write head; and
a plurality of data tracks, wherein each of the plurality of data tracks comprises a respective plurality of data sectors; and
at least one processor configured to:
cause data from a first data track of the hard drive to be copied to a secondary write buffer;
during writing of data to a second data track of the hard drive, determine, based on a position error signal (PES) for a sector of the first data track and a PES for a corresponding sector of the second data track, whether the distance between the sector of the first data track and the corresponding sector of the second data track is less than a threshold distance, wherein the second data track is adjacent to the first data track and the first data track stores previously written data;
in response to determining that the distance between the sector of the first data track and the corresponding sector of the second data track is less than the threshold distance:
set an indicator associated with the first data track indicating that the sector of the first data track may be squeezed;
cause the write head to write to the second data track data to the corresponding sector of the second data track; and
cause data corresponding to the sector of the first data track that may be squeezed to be copied from the secondary write buffer and to another buffer.

19. The storage device of claim 18, wherein copying data from the secondary write buffer to another buffer comprises copying data from the secondary write buffer to the primary write buffer, wherein the at least one processor is further configured to:
cause the write head to write to a third data track of the hard drive the data copied from the secondary write buffer to the primary write buffer

20. The storage device of claim 18, wherein copying data from the secondary write buffer to another buffer comprises copying data from the secondary write buffer to a tertiary write buffer, wherein the at least one processor is further configured to:
in response to determining that at least a threshold portion of the tertiary write buffer is full, cause data from the tertiary write buffer to be copied to a third data track of the hard drive.
